(19) United States
(12) Patent Application Publication
(10) Pub. No.: US 2019/0320205 A1
(43) Pub. Date: Oct. 17, 2019

(54) TEMPLATE MATCHING-BASED PREDICTION METHOD AND APPARATUS

(71) Applicant: Huawei Technologies Co., Ltd., Shenzhen (CN)

(72) Inventor: Yongbing LIN, Beijing (CN)

(21) Appl. No.: 16/452,082

(22) Filed: Jun. 25, 2019

Related U.S. Application Data
(63) Continuation of application No. PCT/CN2017/076043, filed on Mar. 9, 2017.

(30) Foreign Application Priority Data
Dec. 26, 2016 (CN) PCT/CN2016/112200
Jan. 10, 2017 (CN) PCT/CN2017/070735
Jan. 19, 2017 (CN) PCT/CN2017/071733

(51) Int. Cl. H04N 19/61; H04N 19/176; H04N 19/182; H04N 19/90; H04N 19/573

(52) U.S. Cl. CPC H04N 19/61; H04N 19/176; H04N 19/573; H04N 19/90; H04N 19/182

(57) ABSTRACT

A template matching-based prediction method includes: performing matching search separately in at least two reference images of a to-be-processed unit based on a current template to obtain, at each time of the matching search, one set of motion information, one unidirectional matching template, and one unidirectional template distortion value that are corresponding to the reference image, where the current template includes a plurality of reconstructed pixels with a preset quantity at preset positions in a neighboring domain of the to-be-processed unit, and the unidirectional template distortion value represents a difference between the current template and the unidirectional matching template; determining, as target motion information of the to-be-processed unit, motion information corresponding to a smallest one of the obtained unidirectional template distortion values; and constructing a predicted value of the to-be-processed unit based on the target motion information.

### CROSS-REFERENCE TO RELATED APPLICATIONS

This application is a continuation of International Application No. PCT/CN2017/076043, filed on Mar. 9, 2017, which claims priority to International Application No. PCT/CN2017/071733, filed on Jan. 19, 2017, International Application No. PCT/CN2017/070735, filed on Jan. 10, 2017, and International Application No. PCT/CN2016/112200, filed on Dec. 26, 2016. The disclosures of the aforementioned applications are hereby incorporated by reference in their entireties.

### TECHNICAL FIELD

This application relates to the field of video and image technologies, and in particular, to a template matching-based prediction method and apparatus.

### BACKGROUND

A compression rate is a primary performance indicator of a video coding and compression technology, to transmit highest-quality video content by using lowest bandwidth. The compression rate is improved by eliminating redundant information of video content. For all mainstream technical frameworks of a video coding and compression standard, a hybrid video coding scheme based on an image block is used. Main video coding technologies include: prediction, transform and quantization, and entropy coding, where space correlation and time correlation are eliminated by using the prediction technology; frequency domain correlation is eliminated by using the transform and quantization technology; and redundancy of information between code words is further eliminated by using the entropy coding technology.

With continuous improvement of the compression rate in video coding, motion information in a coded code stream accounts for an increasing proportion. The motion information can be derived at a decoding end by using a template matching (TM)-based motion information prediction technology, and the motion information does not need to be transferred, thereby greatly saving coding bits and improving the compression rate. The TM-based motion information prediction technology becomes one of candidate technologies in a next-generation video coding standard.

Generally, an “L”-shaped template is used in a template matching technology. As shown in FIG. 1, a neighboring block on the left of a current block (curBlock) and a neighboring block above the current block together form an “L”-shaped template. Motion information of the template can be obtained through matching search in a reference image Ref0 by using the template. Because the template is close to a spatial location of the current block, their motion information should keep consistent with each other. Therefore, the motion information of the template may be used as motion information of the current block.

The foregoing “L”-shaped template, including the neighboring block on the left of the current block and the neighboring block above the current block, is generated through decoding and reconstruction, and can be obtained both at a coding end and at a decoding end. Therefore, a template matching-based method may be performed at the decoding end to obtain the motion information of the current block, and the motion information does not need to be transferred.

However, only a forward or backward reference image is used during the foregoing template matching search, and the search is unidirectional, but bidirectional prediction based on both the forward reference image and the backward reference image is used during subsequent prediction. This causes a mismatch between template matching search and motion prediction, thereby affecting prediction precision and a prediction effect.

### SUMMARY

Embodiments of this application provide a template matching-based prediction method and apparatus, to resolve a problem of mismatch between template matching search and motion prediction, thereby improving prediction precision.

According to a first aspect, a template matching-based prediction method is provided, including: performing matching search in a first reference image of a to-be-processed unit based on a current template to obtain first motion information, a first matching template, and a first template distortion value that are of the to-be-processed unit, where the current template includes a plurality of reconstructed pixels with a preset quantity at preset positions in a neighboring domain of the to-be-processed unit, and the first template distortion value represents a difference between the first matching template and the current template; updating a pixel value of the current template based on a pixel value of the first matching template; performing matching search in a second reference image of the to-be-processed unit based on the updated current template to obtain second motion information, a second matching template, and a second template distortion value that are of the to-be-processed unit, where the second template distortion value represents a difference between the second matching template and the updated current template; and determining a weighted predicted value of the to-be-processed unit based on the first motion information and the second motion information when the second template distortion value is less than the first template distortion value.

A beneficial effect is as follows: When obtaining a predicted value of the to-be-processed unit, a codec apparatus uses a template matching method to search and predict the to-be-processed unit. This can avoid a problem of mismatch between the search and the prediction, thereby improving prediction precision and a prediction effect, and further improving coding and decoding quality.

With reference to the first aspect, in a possible design, the updating a pixel value of the current template based on a pixel value of the first matching template includes updating the pixel value of the current template in the following manner: T1=(T0−ω0×P1/(1−ω0), where T1 represents a pixel value of the updated current template, TO represents the pixel value of the current template, P1 represents the pixel value of the first matching template, ω0 represents a weighting coefficient corresponding to the first matching template, and ω0 is a positive number less than 1.

A beneficial effect is as follows: Compared with the prior art, an operation of updating the current template is added, and a template matching operation performed after the template update is equivalent to bidirectional matching search, so that a bidirectional search process of template matching is implemented in a relatively simple way, to further improve the prediction precision and the prediction effect in combination with bidirectional prediction.

With reference to the first aspect, in a possible design, ω0 is 0.5.

A beneficial effect is as follows: For the updated template obtained by setting the weighting coefficient corresponding to the first matching template to 0.5, the template matching operation performed after the template update is equivalent to a standard bidirectional matching search process, to further improve the prediction precision and the prediction effect in combination with bidirectional prediction.

With reference to the first aspect, in a possible design, the performing matching search in a first reference image of a to-be-processed unit based on a current template to obtain first motion information, a first matching template, and a first template distortion value that are of the to-be-processed unit includes: traversing, in reconstructed pixels within a preset range of the first reference image, a plurality of first candidate reconstructed-pixel combinations that have a same size and a same shape as the current template, and calculating a plurality of first pixel differences between the plurality of first candidate reconstructed-pixel combinations and the current template; determining the first template distortion value and the first matching template based on a smallest one of the first pixel differences; and determining the first motion information based on an image in which the first matching template is located and a position vector difference between the first matching template and the current template, where the first matching template includes a first candidate reconstructed-pixel combination corresponding to the first template distortion value.

With reference to the first aspect, in a possible design, the performing matching search in a second reference image of the to-be-processed unit based on the updated current template to obtain second motion information, a second matching template, and a second template distortion value that are of the to-be-processed unit includes: traversing, in reconstructed pixels within a preset range of the second reference image, a plurality of second candidate reconstructed-pixel combinations that have a same size and a same shape as the current template, and calculating a plurality of second pixel differences between the plurality of second candidate reconstructed-pixel combinations and the updated current template; determining the second template distortion value and the second matching template based on a smallest one of the second pixel differences; and determining the second motion information based on an image in which the second matching template is located and a position vector difference between the second matching template and the updated current template, where the second matching template includes a second candidate reconstructed-pixel combination corresponding to the second template distortion value.

With reference to the first aspect, in a possible design, the determining a weighted predicted value of the to-be-processed unit based on the first motion information and the second motion information includes: obtaining a first-direction predicted value of the to-be-processed unit from the first reference image based on the first motion information; obtaining a second-direction predicted value of the to-be-processed unit from the second reference image based on the second motion information; and performing weighting calculation on the first-direction predicted value and the second-direction predicted value to obtain the weighted predicted value of the to-be-processed unit.

A beneficial effect is as follows: The weighted predicted value of the to-be-processed unit is directly used as the predicted value of the to-be-processed unit. In this case, a template matching search process is actually equivalent to bidirectional search, and essentially both the first reference image and the second reference image are utilized. This is implemented in a simple manner, and both the prediction precision and the prediction effect can be improved.

With reference to the first aspect, in a possible design, after the performing matching search in a first reference image of a to-be-processed unit based on a current template to obtain first motion information of the to-be-processed unit, a first matching template of the to-be-processed unit, and a first template distortion value that are of the to-be-processed unit, the method further includes: traversing, in reconstructed pixels within a preset range of a third reference image, a plurality of third candidate reconstructed-pixel combinations that have a same size and a same shape as the current template, and calculating a plurality of third pixel differences between the plurality of third candidate reconstructed-pixel combinations and the current template; determining a third template distortion value and a third matching template based on a smallest one of the third pixel differences; and determining third motion information based on an image in which the third matching template is located and a position vector difference between the third matching template and the current template, where the third matching template includes a third candidate reconstructed-pixel combination corresponding to the third template distortion value.

With reference to the first aspect, in a possible design, after the determining third motion information based on an image in which the third matching template is located and a position vector difference between the third matching template and the current template, when the third template distortion value is less than or equal to the first template distortion value, the method further includes: using the third reference image as the first reference image; using the third motion information as the first motion information; using the third template distortion value as the first template distortion value; and using the third matching template as the first matching template.

With reference to the first aspect, in a possible design, when the second template distortion value is not less than the first template distortion value, the method includes: obtaining a predicted value of the to-be-processed unit from the first reference image based on the first motion information.

A beneficial effect is as follows: Adaptive selection can be made from a unidirectional search and unidirectional prediction manner and a bidirectional search and bidirectional prediction manner, thereby improving the prediction precision and the prediction effect when implementation complexity is relatively low.

With reference to the first aspect, in a possible design, the determining a weighted predicted value of the to-be-processed unit based on the first motion information and the second motion information when the second template distortion value is less than the first template distortion value includes: when the second template distortion value is the smallest among the first template distortion value, the second template distortion value, and the third template distortion value, using the weighted predicted value as a predicted value of the to-be-processed unit.

With reference to the first aspect, in a possible design, the method further includes: when the first template distortion value is the smallest among the first template distortion value, the second template distortion value, and the third template distortion value, obtaining a predicted value of the to-be-processed unit from the first reference image based on the first motion information; or when the third template distortion value is the smallest among the first template distortion value, the second template distortion value, and the third template distortion value, obtaining a predicted value of the to-be-processed unit from the third reference image based on the third motion information.

A beneficial effect is as follows: Adaptive selection can be made from two different unidirectional search and unidirectional prediction manners, and a bidirectional search and bidirectional prediction manner. In this case, although implementation complexity is relatively high, adaptive selectivity is relatively good, thereby improving the prediction precision and the prediction effect.

With reference to the first aspect, in a possible design, when the first reference image comes from a forward reference image list of the to-be-processed unit, the third reference image comes from a backward reference image list of the to-be-processed unit; or when the first reference image comes from a backward reference image list of the to-be-processed unit, the third reference image comes from a forward reference image list of the to-be-processed unit.

With reference to the first aspect, in a possible design, after the performing matching search in a second reference image of the to-be-processed unit based on the updated current template to obtain second motion information, a second matching template, and a second template distortion value that are of the to-be-processed unit, the method further includes: updating the second template distortion value based on the weighting coefficient, where an updated second template distortion value is (1−ω0) times the second template distortion value; and correspondingly, the determining a weighted predicted value of the to-be-processed unit based on the first motion information and the second motion information when the second template distortion value is less than the first template distortion value includes: determining the weighted predicted value of the to-be-processed unit based on the first motion information and the second motion information when the updated second template distortion value is less than the first template distortion value.

A beneficial effect is as follows: The second template distortion value is updated based on the weighting coefficient used during the template update, so that a distortion value comparison result is more accurate.

With reference to the first aspect, in a possible design, when the updated second template distortion value is not less than the first template distortion value, the method further includes: obtaining the predicted value of the to-be-processed unit from the first reference image based on the first motion information.

With reference to the first aspect, in a possible design, the determining the weighted predicted value of the to-be-processed unit based on the first motion information and the second motion information when the updated second template distortion value is less than the first template distortion value includes: when the updated second template distortion value is the smallest among the first template distortion value, the updated second template distortion value, and the third template distortion value, using the weighted predicted value as the predicted value of the to-be-processed unit.

With reference to the first aspect, in a possible design, the method further includes: when the first template distortion value is the smallest among the first template distortion value, the updated second template distortion value, and the third template distortion value, obtaining the predicted value of the to-be-processed unit from the first reference image based on the first motion information; or when the third template distortion value is the smallest among the first template distortion value, the updated second template distortion value, and the third template distortion value, obtaining the predicted value of the to-be-processed unit from the third reference image based on the third motion information.

With reference to the first aspect, in a possible design, after the obtaining second motion information, a second matching template, and a second template distortion value that are of the to-be-processed unit, the method further includes: adjusting the second template distortion value to obtain an adjusted second template distortion value; and correspondingly, the determining a weighted predicted value of the to-be-processed unit based on the first motion information and the second motion information when the second template distortion value is less than the first template distortion value includes: when the adjusted second template distortion value is less than the first template distortion value, determining the weighted predicted value of the to-be-processed unit based on the first motion information and the second motion information.

With reference to the first aspect, in a possible design, the adjusting the second template distortion value to obtain an adjusted second template distortion value includes: multiplying the second template distortion value by an adjustment coefficient to obtain the adjusted second template distortion value, where the adjustment coefficient is greater than 0 and less than or equal to 1.

A beneficial effect is as follows: Because a coding cost derived from a template distortion value is not completely consistent with a coding cost in an actual coding process, the template distortion value is adjusted, thereby increasing a probability that the coding cost derived from the template distortion value tends to be consistent with the coding cost in the actual coding process, and improving coding efficiency.

According to a second aspect, a template matching-based prediction apparatus is provided, including: a searching unit, configured to perform matching search in a first reference image of a to-be-processed unit based on a current template to obtain first motion information, a first matching template, and a first template distortion value that are of the to-be-processed unit, where the current template includes a plurality of reconstructed pixels with a preset quantity at preset positions in a neighboring domain of the to-be-processed unit, and the first template distortion value represents a difference between the first matching template and the current template; an updating unit, configured to update a pixel value of the current template based on a pixel value of the first matching template, where the searching unit is further configured to perform matching search in a second reference image of the to-be-processed unit based on the updated current template to obtain second motion information, a second matching template, and a second template distortion value that are of the to-be-processed unit, where the second template distortion value represents a difference between the second matching template and the updated current template; and a determining unit, configured to determine a weighted predicted value of the to-be-processed unit based on the first motion information and the second motion information when the second template distortion value is less than the first template distortion value.

With reference to the second aspect, in a possible design, when updating the pixel value of the current template based on the pixel value of the first matching template, the updating unit updates the pixel value of the current template in the following manner: T1=(T0−ω0×P1)/(1−ω0), where T1 represents a pixel value of the updated current template, T0 represents the pixel value of the current template, P1 represents the pixel value of the first matching template, ω0 represents a weighting coefficient corresponding to the first matching template, and ω0 is a positive number less than 1.

With reference to the second aspect, in a possible design, ω0 is 0.5.

With reference to the second aspect, in a possible design, when performing the matching search in the first reference image of the to-be-processed unit based on the current template to obtain the first motion information, the first matching template, and the first template distortion value that are of the to-be-processed unit, the searching unit is configured to: traverse, in reconstructed pixels within a preset range of the first reference image, a plurality of first candidate reconstructed-pixel combinations that have a same size and a same shape as the current template, and calculate a plurality of first pixel differences between the plurality of first candidate reconstructed-pixel combinations and the current template; determine the first template distortion value and the first matching template based on a smallest one of the first pixel differences; and determine the first motion information based on an image in which the first matching template is located and a position vector difference between the first matching template and the current template, where the first matching template includes a first candidate reconstructed-pixel combination corresponding to the first template distortion value.

With reference to the second aspect, in a possible design, when performing the matching search in the second reference image of the to-be-processed unit based on the updated current template to obtain the second motion information, the second matching template, and the second template distortion value that are of the to-be-processed unit, the searching unit is configured to: traverse, in reconstructed pixels within a preset range of the second reference image, a plurality of second candidate reconstructed-pixel combinations that have a same size and a same shape as the current template, and calculate a plurality of second pixel differences between the plurality of second candidate reconstructed-pixel combinations and the updated current template; determine the second template distortion value and the second matching template based on a smallest one of the second pixel differences; and determine the second motion information based on an image in which the second matching template is located and a position vector difference between the second matching template and the updated current template, where the second matching template includes a second candidate reconstructed-pixel combination corresponding to the second template distortion value.

With reference to the second aspect, in a possible design, when determining the weighted predicted value of the to-be-processed unit based on the first motion information and the second motion information, the determining unit is configured to: obtain a first-direction predicted value of the to-be-processed unit from the first reference image based on the first motion information; obtain a second-direction predicted value of the to-be-processed unit from the second reference image based on the second motion information; and perform weighting calculation on the first-direction predicted value and the second-direction predicted value to obtain the weighted predicted value of the to-be-processed unit.

With reference to the second aspect, in a possible design, after the matching search is performed in the first reference image of the to-be-processed unit based on the current template to obtain the first motion information of the to-be-processed unit and the first matching template of the to-be-processed unit, the searching unit is further configured to: traverse, in reconstructed pixels within a preset range of a third reference image, a plurality of third candidate reconstructed-pixel combinations that have a same size and a same shape as the current template, and calculate a plurality of third pixel differences between the plurality of third candidate reconstructed-pixel combinations and the current template; determine a third template distortion value and a third matching template based on a smallest one of the third pixel differences; and determine third motion information based on an image in which the third matching template is located and a position vector difference between the third matching template and the current template, where the third matching template includes a third candidate reconstructed-pixel combination corresponding to the third template distortion value.

With reference to the second aspect, in a possible design, after the third motion information is determined based on the image in which the third matching template is located and the position vector difference between the third matching template and the current template, when the third template distortion value is less than or equal to the first template distortion value, the searching unit is further configured to: use the third reference image as the first reference image; use the third motion information as the first motion information; use the third template distortion value as the first template distortion value; and use the third matching template as the first matching template.

With reference to the second aspect, in a possible design, when the second template distortion value is not less than the first template distortion value, the determining unit is configured to: obtain a predicted value of the to-be-processed unit from the first reference image based on the first motion information.

With reference to the second aspect, in a possible design, when determining the weighted predicted value of the to-be-processed unit based on the first motion information and the second motion information when the second template distortion value is less than the first template distortion value, the determining unit is configured to: when the second template distortion value is the smallest among the first template distortion value, the second template distortion value, and the third template distortion value, use the weighted predicted value as a predicted value of the to-be-processed unit.

With reference to the second aspect, in a possible design, the determining unit is configured to: when the first template distortion value is the smallest among the first template distortion value, the second template distortion value, and the third template distortion value, obtain a predicted value of the to-be-processed unit from the first reference image based on the first motion information; or when the third template distortion value is the smallest among the first template distortion value, the second template distortion value, and the third template distortion value, obtain a predicted value of the to-be-processed unit from the third reference image based on the third motion information.

With reference to the second aspect, in a possible design, when the first reference image comes from a forward reference image list of the to-be-processed unit, the third reference image comes from a backward reference image list of the to-be-processed unit; or when the first reference image comes from a backward reference image list of the to-be-processed unit, the third reference image comes from a forward reference image list of the to-be-processed unit.

With reference to the second aspect, in a possible design, the updating unit is further configured to: update the second template distortion value based on the weighting coefficient, where an updated second template distortion value is (1−ω0) times the second template distortion value; and correspondingly, the determining unit is configured to determine the weighted predicted value of the to-be-processed unit based on the first motion information and the second motion information when the updated second template distortion value is less than the first template distortion value.

With reference to the second aspect, in a possible design, when the updated second template distortion value is not less than the first template distortion value, the determining unit is further configured to: obtain the predicted value of the to-be-processed unit from the first reference image based on the first motion information.

With reference to the second aspect, in a possible design, when the updated second template distortion value is less than the first template distortion value, the determining unit is configured to: when the updated second template distortion value is the smallest among the first template distortion value, the updated second template distortion value, and the third template distortion value, use the weighted predicted value as the predicted value of the to-be-processed unit.

With reference to the second aspect, in a possible design, when the first template distortion value is the smallest among the first template distortion value, the updated second template distortion value, and the third template distortion value, the determining unit is configured to obtain the predicted value of the to-be-processed unit from the first reference image based on the first motion information; or when the third template distortion value is the smallest among the first template distortion value, the updated second template distortion value, and the third template distortion value, the determining unit is configured to obtain the predicted value of the to-be-processed unit from the third reference image based on the third motion information.

With reference to the second aspect, in a possible design, the determining unit is further configured to: adjust the second template distortion value to obtain an adjusted second template distortion value; and correspondingly, the determining unit is configured to: when the adjusted second template distortion value is less than the first template distortion value, determine the weighted predicted value of the to-be-processed unit based on the first motion information and the second motion information.

With reference to the second aspect, in a possible design, the determining unit is configured to: multiply the second template distortion value by an adjustment coefficient to obtain the adjusted second template distortion value, where the adjustment coefficient is greater than 0 and less than or equal to 1.

According to a third aspect, a template matching-based prediction method is provided, including: performing matching search separately in at least two reference images of a to-be-processed unit based on a current template to obtain, at each time of the matching search, one set of motion information, one unidirectional matching template, and one unidirectional template distortion value that are corresponding to the reference image, where the current template includes a plurality of reconstructed pixels with a preset quantity at preset positions in a neighboring domain of the to-be-processed unit, and the unidirectional template distortion value represents a difference between the current template and the unidirectional matching template; determining, as target motion information of the to-be-processed unit, motion information corresponding to a smallest one of the obtained unidirectional template distortion values; and constructing a predicted value of the to-be-processed unit based on the target motion information.

With reference to the third aspect, in a possible design, after the performing matching search separately in at least two reference images of a to-be-processed unit based on a current template to obtain, at each time of the matching search, one set of motion information, one unidirectional matching template, and one unidirectional template distortion value that are corresponding to the reference image, the method further includes: obtaining a weighted template distortion value based on pixel values of two of the unidirectional matching templates, where the weighted template distortion value represents a weighted difference between the current template and the two unidirectional matching templates, and the weighted template distortion value is corresponding to two sets of motion information corresponding to the two unidirectional matching templates; and correspondingly, the determining, as target motion information of the to-be-processed unit, motion information corresponding to a smallest one of the obtained unidirectional template distortion values includes: determining, as the target motion information, motion information corresponding to a smallest one of the obtained unidirectional template distortion values and the weighted template distortion value.

With reference to the third aspect, in a possible design, the constructing a predicted value of the to-be-processed unit based on the target motion information includes: when the target motion information includes only a first set of motion information, obtaining, based on the first set of motion information, the predicted value of the to-be-processed unit from a first reference image corresponding to the first set of motion information; or when the target motion information includes only a second set of motion information and a third set of motion information, obtaining, based on the second set of motion information, a second predicted value from a second reference image corresponding to the second set of motion information; obtaining, based on the third set of motion information, a third predicted value from a third reference image corresponding to the third set of motion information; and determining a calculated weighted value of the second predicted value and the third predicted value as the predicted value of the to-be-processed unit.

With reference to the third aspect, in a possible design, the matching search includes: traversing, in reconstructed pixels within a preset range of the reference image, a plurality of candidate reconstructed-pixel combinations that have a same size and a same shape as the current template, and calculating a plurality of pixel differences between the plurality of candidate reconstructed-pixel combinations and the current template; determining the unidirectional matching template and the unidirectional template distortion value based on a smallest one of the pixel differences, where the unidirectional matching template includes a candidate reconstructed-pixel combination corresponding to the unidirectional template distortion value; and determining the motion information based on the reference image and a position vector difference between the unidirectional matching template and the current template.

With reference to the third aspect, in a possible design, the performing matching search separately in at least two reference images of a to-be-processed unit based on a current template to obtain, at each time of the matching search, one set of motion information, one unidirectional matching template, and one unidirectional template distortion value that are corresponding to the reference image includes: performing the matching search in at least one reference image of a forward reference image list of the to-be-processed unit based on the current template to obtain one set of forward motion information, one forward matching template, and one forward template distortion value; and performing the matching search in at least one reference image of a backward reference image list of the to-be-processed unit based on the current template to obtain one set of backward motion information, one backward matching template, and one backward template distortion value.

With reference to the third aspect, in a possible design, the obtaining a weighted template distortion value based on pixel values of two of the unidirectional matching templates is expressed by using the following formula: Tw=|ω0×T1+(1−ω0)×T2−Tc|, where Tw represents the weighted template distortion value, T1 and T2 represent the pixel values of the two unidirectional matching templates, Tc represents a pixel value of the current template, ω0 represents a weighting coefficient, ω0≥0, and ω0≤1.

With reference to the third aspect, in a possible design, before the performing matching search separately in at least two reference images of a to-be-processed unit based on a current template, the method further includes: determining that a prediction mode of the to-be-processed unit is a merge mode.

With reference to the third aspect, in a possible design, before the determining, as the target motion information, motion information corresponding to a smallest one of the obtained unidirectional template distortion values and the weighted template distortion value, the method further includes: adjusting the weighted template distortion value to obtain an adjusted weighted template distortion value; and correspondingly, the determining, as the target motion information, motion information corresponding to a smallest one of the obtained unidirectional template distortion values and the weighted template distortion value includes: determining, as the target motion information, motion information corresponding to a smallest one of the obtained unidirectional template distortion values and the adjusted weighted template distortion value.

With reference to the third aspect, in a possible design, the adjusting the weighted template distortion value to obtain an adjusted weighted template distortion value includes: multiplying the weighted template distortion value by an adjustment coefficient to obtain the adjusted weighted template distortion value, where the adjustment coefficient is greater than 0 and less than or equal to 1.

In an embodiment of the present application according to the third aspect, different unidirectional template matching search can be concurrently performed, thereby improving solution execution efficiency.

According to a fourth aspect, a template matching-based prediction device is provided. The device includes a processor and a memory, where the memory stores a computer readable program, and the processor implements, by running the program in the memory, the template matching-based prediction method in the first or third aspect.

According to a fifth aspect, a computer storage medium is provided, and configured to store a computer software instruction for the method in the first or third aspect, where the computer software instruction includes a program designed to perform the first or third aspect.

It should be understood that, technical solutions in the second aspect to the fifth aspect of the embodiments of this application are consistent with technical solutions in the first aspect of the embodiments of this application, and beneficial effects obtained according to the aspects and corresponding implementable designs are similar. Details are not described again.

### BRIEF DESCRIPTION OF DRAWINGS

FIG. 1 is a schematic diagram of an “L”-shaped template in a template matching technology;

FIG. 2 is a schematic diagram of a template matching implementation process;

FIG. 3 is a flowchart of a template matching-based prediction method according to an embodiment of this application;

FIG. 4A and FIG. 4B are flowcharts of a method for obtaining a predicted value of a current block according to an embodiment of this application;

FIG. 5 and FIG. 6 are schematic block diagrams of a video codec apparatus or an electronic device;

FIG. 7 is a schematic block diagram of a video codec system;

FIG. 8 is a structural diagram of a template matching-based prediction apparatus according to an embodiment of this application;

FIG. 9 is a structural diagram of a template matching-based prediction device according to an embodiment of this application;

FIG. 10 is a flowchart of another template matching-based prediction method according to an embodiment of this application;

FIG. 11 is a flowchart of still another template matching-based prediction method according to an embodiment of this application;

FIG. 12 is a structural diagram of another template matching-based prediction device according to an embodiment of this application;

FIG. 13 is a flowchart of yet another template matching-based prediction method according to an embodiment of this application; and

FIG. 14 is a flowchart of a still yet template matching-based prediction method according to an embodiment of this application.

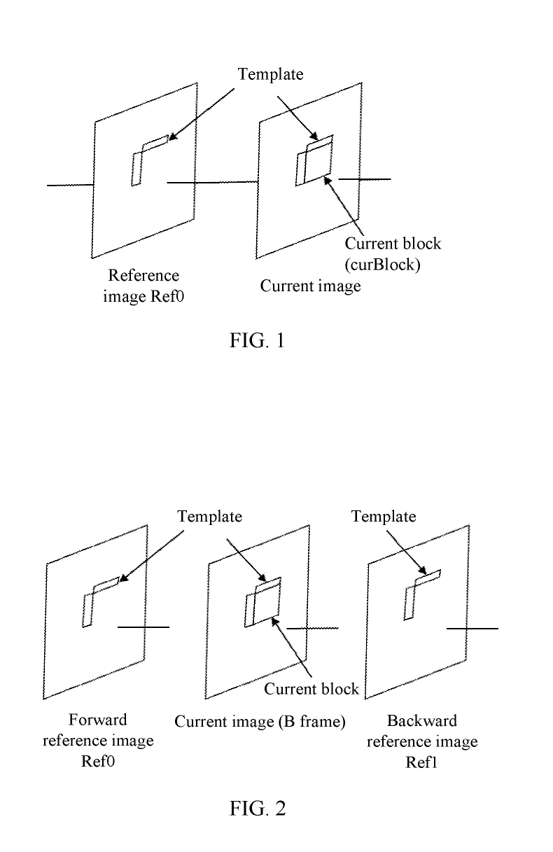

### DESCRIPTION OF EMBODIMENTS

The following clearly describes the technical solutions in the embodiments of this application with reference to the accompanying drawings in the embodiments of this application.

As shown in FIG. 2, in a joint exploration model (JEM), steps of an existing template matching implementation method are as follows:

1. Perform template matching search in a forward reference image Ref0 to obtain forward motion information MV0.

2. Perform template matching search in a backward reference image Ref1 to obtain backward motion information MV1.

3. Perform bidirectional motion prediction on a current block by using MV0 and MV1, to obtain a predicted value.

4. Code or decode an image block based on the predicted value.

Therefore, it can be learned that, during the template matching search, only the forward or backward reference image is used, and the search is unidirectional, but bidirectional prediction based on both the forward reference image and the backward reference image is used during subsequent prediction. This causes a mismatch between template matching search and motion prediction, thereby affecting prediction precision and a prediction effect.

The embodiments of this application provide a template matching-based prediction method and apparatus, to resolve a problem of mismatch between template matching search and motion prediction, thereby improving prediction precision. The method and the apparatus are based on a same application idea. Principles of the method for resolving the problem are similar to principles of the apparatus for resolving the problem. Therefore, implementation of the apparatus and the method may be cross-referenced, and details are not described again.

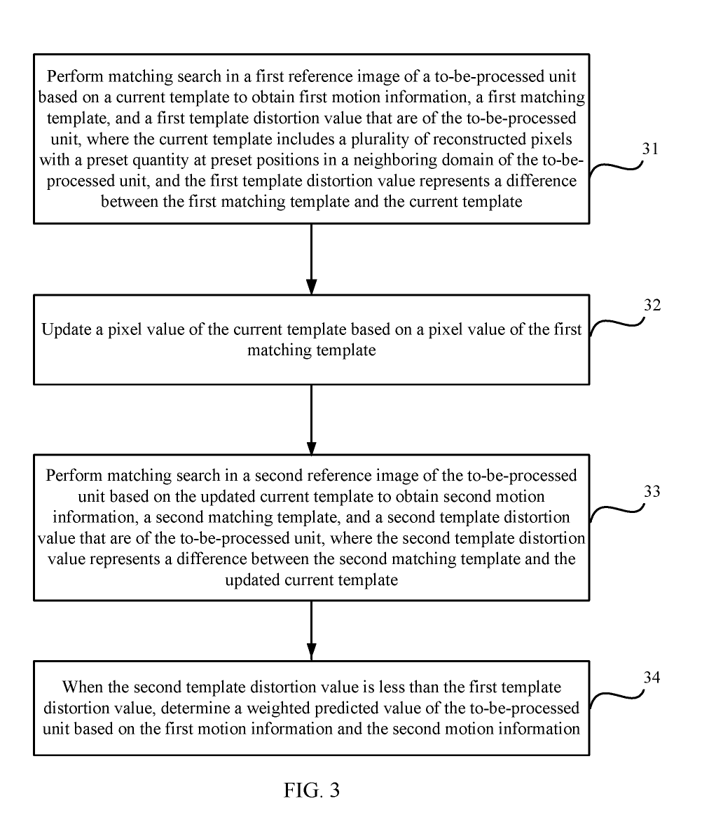

As shown in FIG. 3, an embodiment of this application provides a template matching-based prediction method. A specific process is shown below.

Step 31: Perform matching search in a first reference image of a to-be-processed unit based on a current template to obtain first motion information, a first matching template, and a first template distortion value that are of the to-be-processed unit, where the current template includes a plurality of reconstructed pixels with a preset quantity at preset positions in a neighboring domain of the to-be-processed unit, and the first template distortion value represents a difference between the first matching template and the current template.

In this application, the to-be-processed unit is a current block; and optionally, the current template may be an “L”-shaped template, including a neighboring block on the left of the current block and a neighboring block above the current block. The current template may be close to the current block, or there may be a particular distance between the current template and the current block, and this is not limited in this application.

Specifically, the performing matching search in a first reference image of a to-be-processed unit based on a current template to obtain first motion information, a first matching template, and a first template distortion value that are of the to-be-processed unit is implemented through the following process.

S310. Traverse, in reconstructed pixels within a preset range of the first reference image, a plurality of first candidate reconstructed-pixel combinations that have a same size and a same shape as the current template, and calculate a plurality of first pixel differences between the plurality of first candidate reconstructed-pixel combinations and the current template.

S311. Determine the first template distortion value and the first matching template based on a smallest one of the first pixel differences.

Herein, the smallest one of the first pixel differences is determined as the first template distortion value, and a prediction block corresponding to the smallest one of the first pixel differences is determined as the first matching template.

S312. Determine the first motion information based on an image in which the first matching template is located and a position vector difference between the first matching template and the current template, where the first matching template includes a first candidate reconstructed-pixel combination corresponding to the first template distortion value.

It should be noted that, a process of performing matching search based on the current template in this application is looking for a template that best matches the current template, and a degree of matching thereof is measured by a distortion value; and motion information, pointing to the matching template, of the current template is the first motion information of the current template. Therefore, after the matching search is complete, the first matching template that best matches the current template can be obtained, a value of distortion between the current template and the first matching template is the first template distortion value, and motion information of the current template is the first motion information. The first matching template, the first template distortion value, and the first motion information have a one-to-one correspondence.

Step 32: Update a pixel value of the current template based on a pixel value of the first matching template.

Specifically, the updating a pixel value of the current template based on a pixel value of the first matching template may be implemented by using the following formula:

T1=(T0−ω0×P1)/(1−ω0)

where T1 represents a pixel value of the updated current template, T0 represents the pixel value of the current template, P1 represents the pixel value of the first matching template, ω0 represents a weighting coefficient corresponding to the first matching template, and ω0 is a positive number less than 1.

In a possible implementation, ω0 is set to 0.5. In this case, the updating a pixel value of the current template based on a pixel value of the first matching template may be implemented by using the following formula:

T1=2T0−P1

where T1 represents a pixel value of the updated current template, T0 represents the pixel value of the current template, and P1 represents the pixel value of the first matching template.

It should be understood that a value range of ω0 is 0 to 1, and ω0 is not 1.

Step 33: Perform matching search in a second reference image of the to-be-processed unit based on the updated current template to obtain second motion information, a second matching template, and a second template distortion value that are of the to-be-processed unit, where the second template distortion value represents a difference between the second matching template and the updated current template.

It is worth mentioning that, the first reference image and the second reference image may come from a same reference image list, or may come from different reference image lists; the first reference image and the second reference image may be the same or different; and this is not limited in this application.

Optionally, when the first reference image comes from a forward reference image list of the to-be-processed unit, the second reference image comes from a backward reference image list of the to-be-processed unit; or when the first reference image comes from a backward reference image list of the to-be-processed unit, the second reference image comes from a forward reference image list of the to-be-processed unit.

Specifically, the performing matching search in a second reference image of the to-be-processed unit based on the updated current template to obtain second motion information, a second matching template, and a second template distortion value that are of the to-be-processed unit is implemented through the following process.

S330. Traverse, in reconstructed pixels within a preset range of the second reference image, a plurality of second candidate reconstructed-pixel combinations that have a same size and a same shape as the current template, and calculate a plurality of second pixel differences between the plurality of second candidate reconstructed-pixel combinations and the updated current template.

S331. Determine the second template distortion value and the second matching template based on a smallest one of the second pixel differences.

Herein, the smallest one of the second pixel differences is determined as the second template distortion value, and a prediction block corresponding to the smallest one of the second pixel differences is determined as the second matching template.

S332. Determine the second motion information based on an image in which the second matching template is located and a position vector difference between the second matching template and the updated current template, where the second matching template includes a second candidate reconstructed-pixel combination corresponding to the second template distortion value.

In some feasible implementations, step 33 further includes the following step:

S333. Update the second template distortion value based on the weighting coefficient ω0. Specifically, for example, an updated second template distortion value is (1−ω0) times the second template distortion value before the update.

When ω0 is 0.5, the updated second template distortion value is 0.5 times the second template distortion value before the update.

It should be understood that, because the same weighting coefficient ω0 as that for the updating of the current template is used, the updating of the second template distortion value is related to the updating of the current template during template matching.

It should be further understood that, when S323 is performed, all second template distortion values in subsequent steps are the updated second template distortion value, and details are not described again.

Because the second template distortion value is updated based on the weighting coefficient for the updating of the current template, and represents a prediction error when the second matching template is used, a result of subsequent distortion value comparison better conforms to a real distortion status, so that a more proper predicted value is selected, thereby improving coding efficiency.

Step 34: When the second template distortion value is less than the first template distortion value, determine a weighted predicted value of the to-be-processed unit based on the first motion information and the second motion information.

Specifically, the determining a weighted predicted value of the to-be-processed unit based on the first motion information and the second motion information is implemented through the following process:

S340. Obtain a first-direction predicted value of the to-be-processed unit from the first reference image based on the first motion information.

S341: Obtain a second-direction predicted value of the to-be-processed unit from the second reference image based on the second motion information.

S342: Perform weighting calculation on the first-direction predicted value and the second-direction predicted value to obtain the weighted predicted value of the to-be-processed unit.

It should be noted that, when weighting calculation is performed on the first-direction predicted value and the second-direction predicted value, weighted averaging of the first-direction predicted value and the second-direction predicted value may be performed to obtain the weighted predicted value of the to-be-processed unit. Optionally, averaging of the first-direction predicted value and the second-direction predicted value is performed to obtain the weighted predicted value of the to-be-processed unit.

In a possible implementation, the weighted predicted value of the to-be-processed unit is directly used as a predicted value of the to-be-processed unit. Because an operation of updating the current template is implemented in step 32, a template matching search process in step 33 is actually equivalent to bidirectional search, and essentially both the first reference image and the second reference image are utilized. This is implemented in a simple manner, and both prediction precision and a prediction effect can be improved.

Further, in a possible implementation, after the performing matching search in a first reference image of a to-be-processed unit based on a current template to obtain first motion information of the to-be-processed unit, a first matching template of the to-be-processed unit, and a first template distortion value that are of the to-be-processed unit, the following process further needs to be performed:

traversing, in reconstructed pixels within a preset range of a third reference image, a plurality of third candidate reconstructed-pixel combinations that have a same size and a same shape as the current template, and calculating a plurality of third pixel differences between the plurality of third candidate reconstructed-pixel combinations and the current template;

determining a third template distortion value and a third matching template based on a smallest one of the third pixel differences, where the smallest one of the third pixel differences is determined as the third template distortion value, and a prediction block corresponding to the smallest one of the third pixel differences is determined as the third matching template; and

determining third motion information based on an image in which the third matching template is located and a position vector difference between the third matching template and the current template, where the third matching template includes a third candidate reconstructed-pixel combination corresponding to the third template distortion value.

It should be noted that, when the first reference image comes from a forward reference image list of the to-be-processed unit, the third reference image comes from a backward reference image list of the to-be-processed unit; or when the first reference image comes from a backward reference image list of the to-be-processed unit, the third reference image comes from a forward reference image list of the to-be-processed unit.

Further, after the determining third motion information based on an image in which the third matching template is located and a position vector difference between the third matching template and the current template, when the third template distortion value is less than or equal to the first template distortion value, the method further includes: using the third reference image as the first reference image; using the third motion information as the first motion information; using the third template distortion value as the first template distortion value; and using the third matching template as the first matching template.

It is worth mentioning that, the first reference image and the third reference image may come from a same reference image list, or may come from different reference image lists; the first reference image and the third reference image may be the same or different; and this is not limited in this application.

Further, in a possible implementation, before the determining a weighted predicted value of the to-be-processed unit based on the first motion information and the second motion information, the method further includes:

comparing the first template distortion value and the second template distortion value; and

determining a predicted value of the to-be-processed unit based on a comparison result.

Specifically, the determining a predicted value of the to-be-processed unit based on a comparison result includes the following two cases:

Case 1: When the first template distortion value is less than or equal to the second template distortion value, the predicted value of the to-be-processed unit is obtained from the first reference image based on the first motion information.

Case 2: When the first template distortion value is greater than or equal to the second template distortion value, the weighted predicted value is used as the predicted value of the to-be-processed unit.

Therefore, it can be learned that, in this implementation, the foregoing prediction method can support adaptive selection from a unidirectional search and unidirectional prediction manner and a bidirectional search and bidirectional prediction manner, thereby improving the prediction precision and the prediction effect when implementation complexity is relatively low.

Further, in another possible implementation, before the determining a weighted predicted value of the to-be-processed unit based on the first motion information and the second motion information, the method further includes:

comparing the first template distortion value, the second template distortion value, and the third template distortion value; and

determining a predicted value of the to-be-processed unit based on a comparison result.

Specifically, the determining a predicted value of the to-be-processed unit based on a comparison result includes the following three cases:

Case 1: When the first template distortion value is the smallest among the first template distortion value, the second template distortion value, and the third template distortion value, the predicted value of the to-be-processed unit is obtained from the first reference image based on the first motion information.

Case 2: When the third template distortion value is the smallest among the first template distortion value, the second template distortion value, and the third template distortion value, the predicted value of the to-be-processed unit is obtained from the third reference image based on the third motion information.

Case 3: When the second template distortion value is the smallest among the first template distortion value, the second template distortion value, and the third template distortion value, the weighted predicted value is used as the predicted value of the to-be-processed unit.

In this implementation, adaptive selection can be made from two different unidirectional search and unidirectional prediction manners, and a bidirectional search and bidirectional prediction manner. In this case, although implementation complexity is relatively high, adaptive selectivity is relatively good, thereby improving the prediction effect and the prediction precision.

The method in FIG. 3 is described in detail below based on actual application scenarios.

Scenario 1

In Scenario 1, a predicted value of a current block is obtained through bidirectional search and bidirectional prediction of template matching. A specific process is as follows:

1. Perform matching search in a forward reference image RefO of the current block based on a current template to obtain forward motion information MVO of the current block and a forward predicted value of the current template (namely, a pixel value P1 of a first matching template).

2. Update the current template by using the following formula:

T1=2T0−P1

where T1 represents a pixel value of the updated current template, T0 represents a pixel value of the current template, and P1 represents the forward predicted value of the current template.

3. Perform template matching search in a backward reference image of the current block by using the updated current template T1, to obtain backward motion information MV1 of the current block.

4. Perform bidirectional prediction on the current block by using MV0 and MV1, to obtain a forward predicted value Pred0 of the current block and a backward predicted value Pred1 of the current block.

5. Calculate an average of the forward predicted value Pred0 of the current block and the backward predicted value Pred1 of the current block to obtain the predicted value of the current block.

In this way, compared with the prior art, because an operation of updating the current template is added, after the current template is updated, a template matching search process in a subsequent step is equivalent to bidirectional search, and essentially both the forward reference image and the backward reference image are utilized. A bidirectional search process of template matching is implemented in a simple manner, thereby improving the prediction precision and the prediction effect.

It should be noted that steps 1 to 3 in Scenario 1 may be iteratively performed a plurality of times to obtain higher-precision motion information.

It should be noted that, if the bidirectional prediction in step 4 is performed in a weighted prediction manner, for example, predBi=w0*Pred0+ω1*Pred1, the formula used in a template updating process in step 2 is changed to the following form:

T1=(T0−ω0×P1)/ω1

In the formula, w0 is a weighting coefficient corresponding to the forward predicted value Pred0, ω1 is a weighting coefficient corresponding to the backward predicted value Pred1, and ω0+ω1=1.

If the bidirectional prediction is performed in the weighted prediction manner, the related weighting coefficients may be calculated based on distortion values corresponding to forward prediction and backward prediction. In principle, more accurate prediction is allocated with a larger weight. In other words, smaller prediction distortion is allocated with a larger weight. For example:

ω0=cost1/(cost0+cost1), and ω1=cost0/(cost0+cost1)

where cost0 is a distortion value, corresponding to the forward prediction, of the current template, and cost1 is a distortion value, corresponding to the backward prediction, of the current template.

Weighted prediction is especially suitable for a scenario of brightness gradient. In the template matching-based prediction method in this application, the weighting coefficients can be adaptively calculated, and different weighting coefficients are allowed in different regions inside an image, so that local adaptability is better, facilitating more accurate prediction.

Below are reasons why the template matching search in step 3 in Scenario 1 is equivalent to bidirectional search.

The template matching in step 3 is looking for a backward predicted value Pred1 from the backward reference image Ref1, so that the backward predicted value Pred1 best matches the template. A matching process is minimizing (T1−Pred1).

$$T 1 - Pred 1 = ( 2 \times T 0 - Pred 0 ) - Pred 1 = 2 \times [ T 0 - Pred 0 + Pred 1 ) / 2 ]$$

In the formula, (Pred0+Pred1)/2 is the weighted predicted value of the current block, and minimizing (T0−(Pred0+Pred1)/2) is a standard bidirectional matching search process.

It can be learned that a process of minimizing (T1−Pred1) is equivalent to a process of minimizing (T0−(Pred0+Pred1)/2). Therefore, the matching search process in step 3 is actually bidirectional matching search. In addition, it can be learned from the foregoing formula that a template difference (T1−Pred1) is equivalent to twice a difference (T0−(Pred0+Pred1)/2) between the current template and a bidirectionally predicted value. Therefore, after normalization, 1/2*(T1−Pred1) is equivalent to representing the difference between the current template and the bidirectionally predicted value, and is used for subsequent cost comparison.

It is worth mentioning that, in Scenario 1, for an implementation process of obtaining the predicted value of the current block through bidirectional search and bidirectional prediction of template matching, the matching search of the current template in the backward reference image Ref1 may be performed first to obtain the backward motion information MV1 of the current block and the backward predicted value P1 of the current template; and then the current template is updated by using the backward predicted value P1, so that a process of bidirectional template matching search in the forward reference image is performed to obtain the predicted value of the current block. All other processes are similar, and details are not described herein again.

Scenario 2

In Scenario 2, a predicted value of a current block is obtained by adaptively selecting a prediction manner from two different unidirectional search and unidirectional prediction manners (including forward search and forward prediction, and backward search and backward prediction) and a bidirectional search and bidirectional prediction manner. A specific process is as follows:

1. Perform matching search in a forward reference image Ref0 of the current block based on a current template to obtain forward motion information MV0 of the current block, a forward predicted value of the current template (namely, a pixel value of a matching template), and a first distortion value cost0 between the current template and the forward predicted value of the current template.

2. Perform matching search in a backward reference image Ref1 of the current block based on the current template to obtain backward motion information MV1 of the current block, a backward predicted value of the current template (namely, a pixel value of a matching template), and a second distortion value cost2 between the current template and the backward predicted value of the current template.

3. Compare cost0 and cost2, and select a prediction manner corresponding to a smaller one of cost0 and cost2 to obtain bidirectional motion information of the current block, and a third distortion value cost1 between the current template and a weighted predicted value of the current template.

Specifically, in a first implementation, if cost0 is less than cost2, the current template is updated by using the following formula:

T1=2T0−P1

where T1 represents a pixel value of the updated current template, T0 represents a pixel value of the current template, and P1 represents the forward predicted value of the current template.

Then, template matching search is performed in the backward reference image of the current block by using the updated current template T1, to obtain backward motion information MV1′ of the current block, a weighted predicted value of the updated current template, and a third distortion value cost1 of the updated current template.

In this case, the bidirectional motion information of the current block is MV0 and MV1′.

Specifically, in a second implementation, if cost1 is not less than cost2, the current template is updated by using the following formula:

T1=2T0−P1′

where T1 represents a pixel value of the updated current template, T0 represents a pixel value of the current template, and P1′ represents the backward predicted value of the current template.

Then, template matching search is performed in the forward reference image of the current block by using the updated current template T1, to obtain forward motion information MV0′ of the current block, a weighted predicted value of the updated current template, and a third distortion value cost1 of the updated current template.

In this case, the bidirectional motion information of the current block is MV0′ and MV1.

4. Compare cost1 and the smaller one of cost0 and cost2, and select a prediction manner corresponding to a smallest distortion value to obtain the predicted value of the current block.

Specifically, in the first implementation in step 3:

If cost0 is less than cost1, a forward predicted value of the current block is obtained from the forward reference image of the current block by using the forward motion information MV0, and is used as the predicted value of the current block.

If cost0 is not less than cost1, a forward predicted value of the current block is obtained from the forward reference image of the current block by using the forward motion information MV0 and the backward motion information MV1′, a backward predicted value of the current block is obtained from the backward reference image of the current block, and weighting calculation is performed on the forward predicted value of the current block and the backward predicted value of the current block to obtain the predicted value of the current block.

Specifically, in the second implementation in step 3:

If cost2 is less than cost1, the backward predicted value of the current block is obtained from the backward reference image of the current block by using the backward motion information MV1, and is used as the predicted value of the current block.

If cost2 is not less than cost1, the forward predicted value of the current block is obtained from the forward reference image of the current block by using the forward motion information MV0′ and the backward motion information MV1, the backward predicted value of the current block is obtained from the backward reference image of the current block, and weighting calculation is performed on the forward predicted value of the current block and the backward predicted value of the current block to obtain the predicted value of the current block.

It should be noted that, three unidirectional template matching search processes need to be performed in Scenario 2, with best adaptability and a best prediction effect but relatively high implementation complexity.

Scenario 3

In Scenario 3, a predicted value of a current block is obtained by adaptively selecting a prediction manner from a determined unidirectional search and unidirectional manner and a bidirectional search and bidirectional prediction manner. A specific process is as follows.

Specifically, the unidirectional search and unidirectional prediction manner may be determined in advance based on some indicators. For example, (1) before template matching search is performed, perform, according to an initial value of a forward motion vector and an initial value of a backward motion vector, matching search based on a current template, to respectively obtain a forward predicted value corresponding to the current template and a forward distortion value cost0′ of the current template, and obtain a backward predicted value corresponding to the current template and a backward distortion value cost2′ of the current template; and select a unidirectional prediction manner corresponding to a smaller one of cost0′ and cost2′. For another example, (2) perform determining based on a time-domain distance between the current block and a forward reference image and a time-domain distance between the current block and a backward reference image, and select a unidirectional prediction manner corresponding to a smaller one of the two time-domain distances.

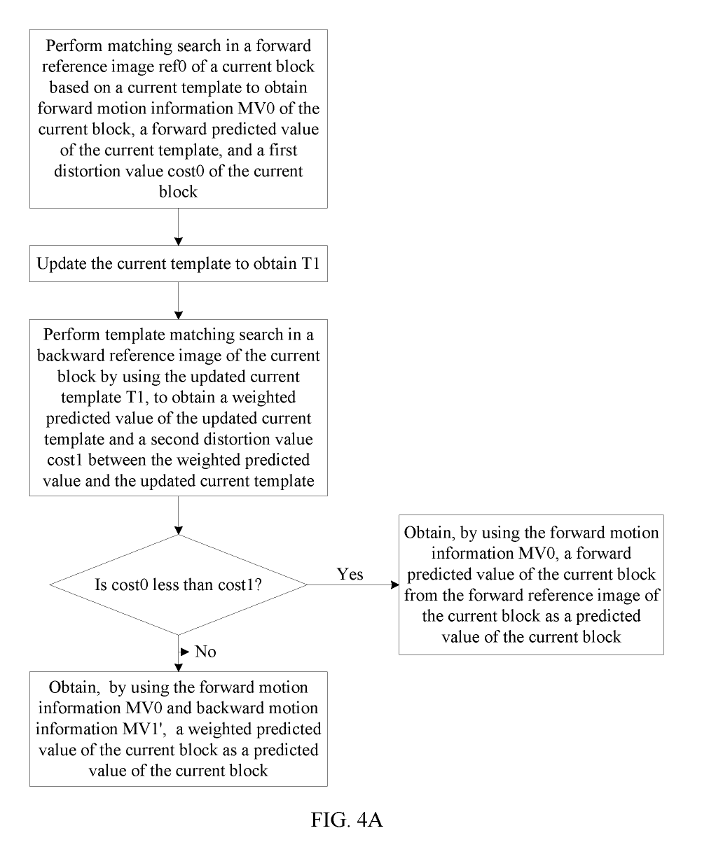

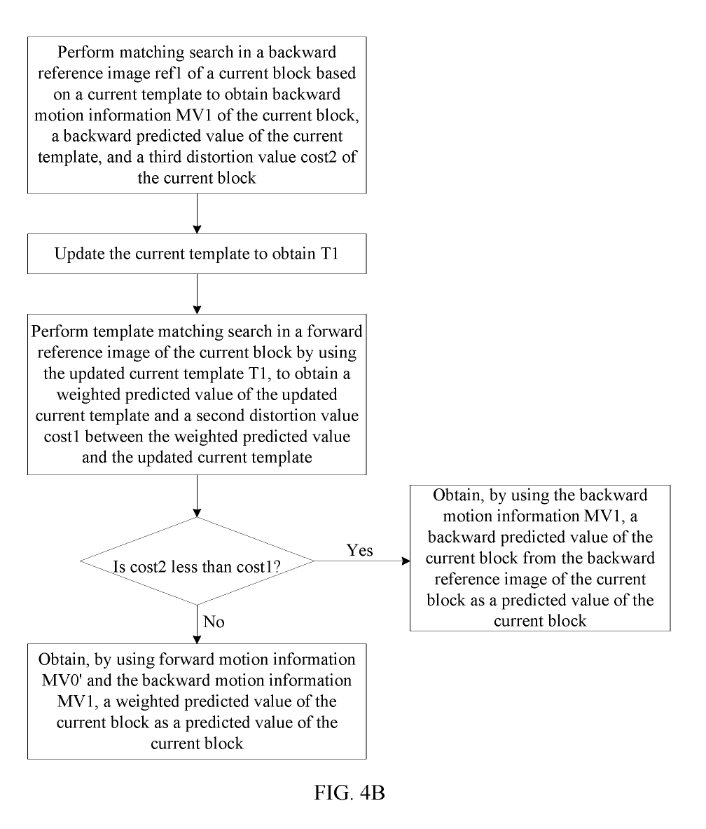

If the determined unidirectional prediction manner is forward search and forward prediction, reference may be made to FIG. 4A for a specific implementation flowchart.

1. Perform matching search in a forward reference image Ref0 of a current block based on a current template to obtain forward motion information MV0 of the current block, a forward predicted value of the current template (namely, a pixel value of a matching template), and a first distortion value cost0 between the current template and the forward predicted value of the current template.

2. Update the current template by using the following formula:

T1=2T0−P1

where T1 represents a pixel value of the updated current template, T0 represents a pixel value of the current template, and P1 represents the forward predicted value of the current template.

3. Perform template matching search in the forward reference image of the current block by using the updated current template T1, to obtain a weighted predicted value of the updated current template and a second distortion value cost1 between the weighted predicted value and the updated current template.

4. Compare cost0 and cost1.

5. Select, based on a comparison result of cost0 and cost1, a prediction manner corresponding to a smaller one of cost0 and cost1 to obtain a predicted value of the current block.

Specifically, if cost0 is less than cost1, a forward predicted value of the current block is obtained from the forward reference image of the current block by using the forward motion information MV0, and is used as the predicted value of the current block.

If cost0 is not less than cost1, a forward predicted value of the current block is obtained from the forward reference image of the current block by using the forward motion information MV0 and backward motion information MV1′, a backward predicted value of the current block is obtained from the backward reference image of the current block, and weighting calculation is performed on the forward predicted value of the current block and the backward predicted value of the current block to obtain the predicted value of the current block.

If the determined unidirectional prediction manner is backward search and backward prediction, reference may be made to FIG. 4B for a specific implementation flowchart.

1. Perform matching search in a backward reference image Ref1 of a current block based on a current template to obtain backward motion information MV1′ of the current block, a backward predicted value of the current template (namely, a pixel value of a matching template), and a third distortion value cost2 between the current template and the backward predicted value of the current template.

2. Update the current template by using the following formula:

T1=2T0−P1′

where T1 represents a pixel value of the updated current template, T0 represents a pixel value of the current template, and P1′ represents the backward predicted value of the current template.

3. Perform template matching search in the backward reference image of the current block by using the updated current template T1, to obtain a weighted predicted value of the updated current template and a second distortion value cost1 between the weighted predicted value and the updated current template.

4. Compare cost1 and cost2.

5. Select, based on a comparison result of cost1 and cost2, a prediction manner corresponding to a smaller one of cost1 and cost2 to obtain a predicted value of the current block.

If cost2 is not less than cost1, a forward predicted value of the current block is obtained from a forward reference image of the current block by using forward motion information MV0′ and the backward motion information MV1, a backward predicted value of the current block is obtained from the backward reference image of the current block, and weighting calculation is performed on the forward predicted value of the current block and the backward predicted value of the current block to obtain the predicted value of the current block.

If cost2 is less than cost1, a backward predicted value of the current block is obtained from the backward reference image of the current block by using the backward motion information MV1, and is used as the predicted value of the current block.

It should be noted that Scenario 3 has one less template matching search process than Scenario 2, thereby reducing complexity and improving prediction precision.

Therefore, a predicted value is obtained based on the foregoing prediction method, to perform coding or decoding of an image block.

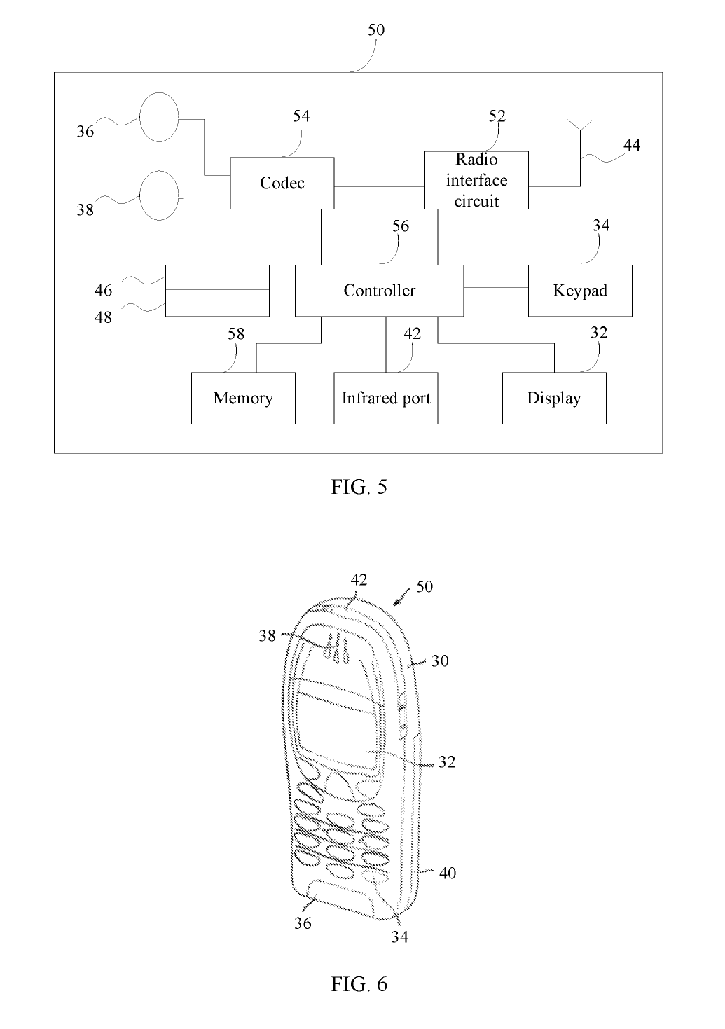

FIG. 5 is a schematic block diagram of a video codec apparatus 50 or an electronic device 50. The apparatus or electronic device may include a prediction device in an embodiment of this application. FIG. 6 is a schematic diagram of an apparatus used for video coding according to an embodiment of this application. The following describes units in FIG. 5 and FIG. 6.

The electronic device 50 may be, for example, a mobile terminal or user equipment in a wireless communications system. It should be understood that the embodiments of this application may be implemented in any electronic device or any apparatus that possibly needs to code and decode, or code, or decode a video image.

The apparatus 50 may include a housing 30 configured to house and protect a device. The apparatus 50 may further include a display 32 in a form of a liquid crystal display. In another embodiment of this application, the display may be any proper display suitable for displaying images or videos. The apparatus 50 may further include a keypad 34. In another embodiment of this application, any proper data or user interface mechanism may be used. For example, a user interface may be implemented as a virtual keypad or a data entry system, to serve as a part of a touch-sensitive display. The apparatus may include a microphone 36 or any proper audio input, and the audio input may be digital or analog signal input. The apparatus 50 may further include an audio output device. In this embodiment of this application, the audio output device may be any one of the following: a headset 38, a speaker, or an analog audio or digital audio output device. The apparatus 50 may further include a battery 40. In another embodiment of this application, the device may be supplied with power by any proper mobile energy device, for example, a solar cell, a fuel cell, or a clock mechanism generator. The apparatus may further include an infrared port 42 configured to perform short-range line-of-sight communication with another device. In another embodiment, the apparatus 50 may further include any proper short-range communications solution, for example, a Bluetooth wireless connection or a USB/firewire wired connection.

The apparatus 50 may include a controller 56 or a processor configured to control the apparatus 50. The controller 56 may be connected to a memory 58. In this embodiment of this application, the memory may store data in an image form and data in an audio form, and/or may store an instruction executed on the controller 56. The controller 56 may be further connected to a codec 54 for coding and decoding audio and/or video data, or a codec 54 that implements coding and decoding under assistance of the controller 56.

The apparatus 50 may further include a card reader 48 and a smart card 46 that are configured to provide user information and are suitable for providing authentication information used for network authentication and user authorization, for example, a UICC and a UICC reader.

The apparatus 50 may further include a radio interface circuit 52. The radio interface circuit is connected to the controller, and is suitable for generating, for example, a wireless communications signal for communication with a cellular communications network, a wireless communications system, or a wireless local area network. The apparatus 50 may further include an antenna 44. Connected to the radio interface circuit 52, the antenna is configured to: send radio frequency signals generated by the radio interface circuit 52 to another apparatus (or a plurality of other apparatuses), and receive radio frequency signals from another apparatus (or a plurality of other apparatuses).

In some embodiments of this application, the apparatus 50 includes a camera capable of recording or detecting single frames, and the codec 54 or the controller receives and processes these single frames. In some embodiments of this application, the apparatus may receive to-be-processed video and image data from another device before transmitting and/or storing the data. In some embodiments of this application, the apparatus 50 may receive, through wireless or wired connection, an image for coding or decoding.

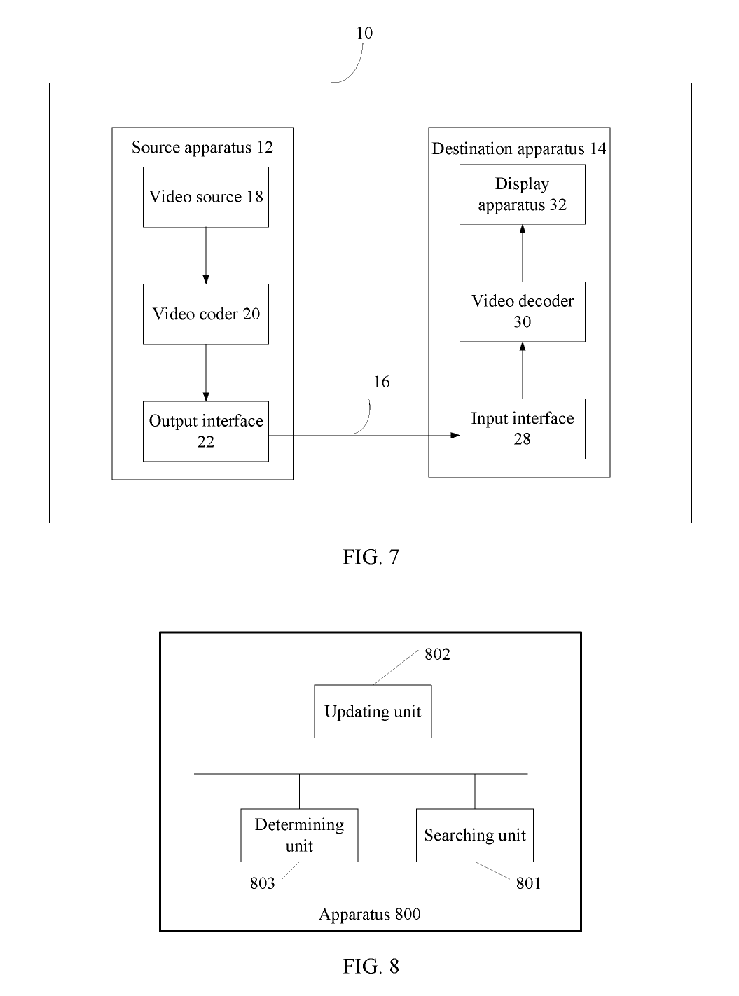

FIG. 7 is a schematic block diagram of another video codec system 10 according to an embodiment of this application. As shown in FIG. 7, the video codec system 10 includes a source apparatus 12 and a destination apparatus 14. The source apparatus 12 generates coded video data. Therefore, the source apparatus 12 may be referred to as a video coding apparatus or a video coding device. The destination apparatus 14 can decode the coded video data generated by the source apparatus 12. Therefore, the destination apparatus 14 may be referred to as a video decoding apparatus or a video decoding device. The source apparatus 12 and the destination apparatus 14 may be an instance of a video codec apparatus or a video codec device. The source apparatus 12 and the destination apparatus 14 may include a wide range of apparatuses, including a desktop computer, a mobile computing apparatus, a notebook (for example, laptop) computer, a tablet computer, a set-top box, a handheld phone such as a smartphone, a TV set, a camera, a display apparatus, a digital media player, a video game control console, an in-vehicle computer, or the like.

The destination apparatus 14 can receive, through a channel 16, coded video data from the source apparatus 12. The channel 16 may include one or more media and/or apparatuses capable of moving coded video data from the source apparatus 12 to the destination apparatus 14. In an instance, the channel 16 may include one or more communications media that enable the source apparatus 12 to directly transmit coded video data to the destination apparatus 14 in real time. In this instance, the source apparatus 12 may modulate coded video data according to a communications standard (for example, a wireless communications protocol), and may transmit modulated video data to the destination apparatus 14. The one or more communications media may include a wireless and/or wired communications medium, for example, a radio frequency (RF) spectrum or one or more physical transmission lines. The one or more communications media may form a part of a packet-based network (for example, a local area network, a wide area network, or a global network (such as the Internet)). The one or more communications media may include a router, a switch, and a base station, or another device that facilitates communication from the source apparatus 12 to the destination apparatus 14.

In another instance, the channel 16 may include a storage medium for storing the coded video data generated by the source apparatus 12. In this instance, the destination apparatus 14 may access the storage medium through magnetic disk access or card access. The storage medium may include a plurality of types of local-access data storage media, for example, a Blu-ray disc, a DVD, a CD-ROM, a flash memory, or another proper digital storage medium for storing coded video data.

In another instance, the channel 16 may include a file server, or another intermediate storage apparatus for storing the coded video data generated by the source apparatus 12. In this instance, the destination apparatus 14 may access, through streaming transmission or downloading, coded video data stored in the file server or in the another intermediate storage apparatus. The file server may be a type of server capable of storing the coded video data and transmitting the coded video data to the destination apparatus 14. The file server includes a web server (for example, used for a website), a File Transfer Protocol (FTP) server, a network attached storage (NAS) apparatus, and a local disk drive.

The destination apparatus 14 may access the coded video data through a standard data connection (for example, an Internet connection). An instance type of the data connection includes a radio channel (for example, a Wi-Fi connection) or a wired connection (for example, DSL or a cable modem) suitable for accessing the coded video data stored in the file server, or a combination of the radio channel and the wired connection. Transmission of the coded video data from the file server may be streaming transmission, downloading transmission, or a combination of streaming transmission and downloading transmission.

Technologies of this application are not limited to a wireless application scenario. For example, the technologies may be applied to video coding and decoding that supports a plurality of multimedia applications, such as the following applications: over-the-air television broadcasting, cable television transmitting, satellite television transmitting, streaming-transmission video transmission (for example, through the Internet), coding of video data stored in a data storage medium, decoding of video data stored in a data storage medium, or other applications. In some instances, the video codec system 10 may support, through configuration, one-way or two-way video transmission, to support applications, such as video streaming transmission, video play, video broadcasting, and/or videotelephony.

In the instance in FIG. 7, the source apparatus 12 includes a video source 18, a video coder 20, and an output interface 22. In some instances, the output interface 22 may include a modulator/demodulator (modem) and/or a transmitter. The video source 18 may include a video capture apparatus (for example, a video camera), a video archive including previously captured video data, a video input interface for receiving video data from a video content provider, a computer graphics system for generating video data, or a combination of the foregoing video data sources.

The video coder 20 can code video data from the video source 18. In some instances, the source apparatus 12 directly transmits coded video data to the destination apparatus 14 through the output interface 22. Alternatively, the coded video data may be stored in a storage medium or a file server, so that the destination apparatus 14 can access the coded video data later for decoding and/or play.

In the instance in FIG. 7, the destination apparatus 14 includes an input interface 28, a video decoder 30, and a display apparatus 32. In some instances, the input interface 28 includes a receiver and/or a modem. The input interface 28 can receive coded video data through the channel 16. The display apparatus 32 may be integrated into the destination apparatus 14, or may be outside the destination apparatus 14. Usually, the display apparatus 32 displays decoded video data. The display apparatus 32 may include a plurality of display apparatuses, for example, a liquid crystal display (LCD), a plasma display, an organic light-emitting diode (OLED) display, or a display apparatus of another type.

The video coder 20 and the video decoder 30 may perform operations based on a video compression standard (for example, the High Efficiency Video Coding H.265 standard), and may follow the HEVC Test Model (HM). Text description ITU-TH.265 (V3) (04/2015) of the H.265 standard was released on Apr. 29, 2015, and can be downloaded from http://handle.itu.int/11.1002/1000/12455, which is incorporated herein by reference in its entirety.

Based on the foregoing method embodiments, as shown in FIG. 8, an embodiment of this application provides a template matching-based prediction apparatus 800. As shown in FIG. 8, the apparatus 800 includes a searching unit 801, an updating unit 802, and a determining unit 803.

The searching unit 801 is configured to perform matching search in a first reference image of a to-be-processed unit based on a current template to obtain first motion information, a first matching template, and a first template distortion value that are of the to-be-processed unit, where the current template includes a plurality of reconstructed pixels with a preset quantity at preset positions in a neighboring domain of the to-be-processed unit, and the first template distortion value represents a difference between the first matching template and the current template.

The updating unit 802 is configured to update a pixel value of the current template based on a pixel value of the first matching template.

The searching unit 801 is further configured to perform matching search in a second reference image of the to-be-processed unit based on the updated current template to obtain second motion information, a second matching template, and a second template distortion value that are of the to-be-processed unit, where the second template distortion value represents a difference between the second matching template and the updated current template.

The determining unit 803 is configured to determine a weighted predicted value of the to-be-processed unit based on the first motion information and the second motion information when the second template distortion value is less than the first template distortion value.

Optionally, the updating, by the updating unit 802, a pixel value of the current template based on a pixel value of the first matching template conforms to the following expression:

T1=(T031 ω0×P1)/(1−ω0)

where T1 represents a pixel value of the updated current template, T0 represents the pixel value of the current template, P1 represents the pixel value of the first matching template, ω0 represents a weighting coefficient corresponding to the first matching template, and ω0 is a positive number less than 1.

It should be understood that a value range of ω0 is 0 to 1, and ω0 is not 1.

Optionally, ω0 is 0.5.

Optionally, when performing the matching search in the first reference image of the to-be-processed unit based on the current template to obtain the first motion information, the first matching template, and the first template distortion value that are of the to-be-processed unit, the searching unit 801 is configured to:

traverse, in reconstructed pixels within a preset range of the first reference image, a plurality of first candidate reconstructed-pixel combinations that have a same size and a same shape as the current template, and calculate a plurality of first pixel differences between the plurality of first candidate reconstructed-pixel combinations and the current template;

determine the first template distortion value and the first matching template based on a smallest one of the first pixel differences; and

determine the first motion information based on an image in which the first matching template is located and a position vector difference between the first matching template and the current template, where the first matching template includes a first candidate reconstructed-pixel combination corresponding to the first template distortion value.

Optionally, when performing the matching search in the second reference image of the to-be-processed unit based on the updated current template to obtain the second motion information, the second matching template, and the second template distortion value that are of the to-be-processed unit, the searching unit 801 is configured to:

traverse, in reconstructed pixels within a preset range of the second reference image, a plurality of second candidate reconstructed-pixel combinations that have a same size and a same shape as the current template, and calculate a plurality of second pixel differences between the plurality of second candidate reconstructed-pixel combinations and the updated current template;

determine the second template distortion value and the second matching template based on a smallest one of the second pixel differences; and

determine the second motion information based on an image in which the second matching template is located and a position vector difference between the second matching template and the updated current template, where the second matching template includes a second candidate reconstructed-pixel combination corresponding to the second template distortion value.

Optionally, when determining the weighted predicted value of the to-be-processed unit based on the first motion information and the second motion information, the determining unit 803 is configured to:

obtain a first-direction predicted value of the to-be-processed unit from the first reference image based on the first motion information;

obtain a second-direction predicted value of the to-be-processed unit from the second reference image based on the second motion information; and

perform weighting calculation on the first-direction predicted value and the second-direction predicted value to obtain the weighted predicted value of the to-be-processed unit.

Optionally, after the matching search is performed in the first reference image of the to-be-processed unit based on the current template to obtain the first motion information of the to-be-processed unit and the first matching template of the to-be-processed unit, the searching unit 801 is further configured to:

traverse, in reconstructed pixels within a preset range of a third reference image, a plurality of third candidate reconstructed-pixel combinations that have a same size and a same shape as the current template, and calculate a plurality of third pixel differences between the plurality of third candidate reconstructed-pixel combinations and the current template;

determine a third template distortion value and a third matching template based on a smallest one of the third pixel differences; and

determine third motion information based on an image in which the third matching template is located and a position vector difference between the third matching template and the current template, where the third matching template includes a third candidate reconstructed-pixel combination corresponding to the third template distortion value.

Optimally, after the third motion information is determined based on the image in which the third matching template is located and the position vector difference between the third matching template and the current template, when the third template distortion value is less than or equal to the first template distortion value, the searching unit 801 is further configured to:

use the third reference image as the first reference image;

use the third motion information as the first motion information;

use the third template distortion value as the first template distortion value; and

use the third matching template as the first matching template.

Optionally, before determining the weighted predicted value of the to-be-processed unit based on the first motion information and the second motion information, the determining unit 803 is further configured to:

compare the first template distortion value and the second template distortion value.

Optionally, when a comparison result is that the second template distortion value is not less than the first template distortion value, the determining unit 803 is configured to:

obtain a predicted value of the to-be-processed unit from the first reference image based on the first motion information.

Optionally, before determining the weighted predicted value of the to-be-processed unit based on the first motion information and the second motion information, the determining unit 803 is further configured to:

compare the first template distortion value, the second template distortion value, and the third template distortion value.

Optionally, when determining the weighted predicted value of the to-be-processed unit based on the first motion information and the second motion information when the second template distortion value is less than the first template distortion value, the determining unit 803 is configured to:

when the second template distortion value is the smallest among the first template distortion value, the second template distortion value, and the third template distortion value, use the weighted predicted value as a predicted value of the to-be-processed unit.

Optionally, the determining unit 803 is configured to:

when a comparison result is that the first template distortion value is the smallest among the first template distortion value, the second template distortion value, and the third template distortion value, obtain a predicted value of the to-be-processed unit from the first reference image based on the first motion information; or

when a comparison result is that the third template distortion value is the smallest among the first template distortion value, the second template distortion value, and the third template distortion value, obtain a predicted value of the to-be-processed unit from the third reference image based on the third motion information.

Optionally, when the first reference image comes from a forward reference image list of the to-be-processed unit, the third reference image comes from a backward reference image list of the to-be-processed unit; or when the first reference image comes from a backward reference image list of the to-be-processed unit, the third reference image comes from a forward reference image list of the to-be-processed unit.

Optionally, the updating unit 802 is further configured to update the second template distortion value based on the weighting coefficient ω0. Specifically, for example, an updated second template distortion value is (1−ω0) times the second template distortion value before the update.

When ω0 is 0.5, the updated second template distortion value is 0.5 times the second template distortion value before the update.

It should be understood that, because the same weighting coefficient ω0 as that for the updating of the current template is used, the updating of the second template distortion value is related to the updating of the current template during template matching.

It should be further understood that, when the updating unit 802 is further configured to update the second template distortion value based on the weighting coefficient ω0, all second template distortion values in subsequent steps performed by other units are the updated second template distortion value, and details are not described again.

Because the second template distortion value is updated based on the weighting coefficient for the updating of the current template, and represents a prediction error when the second matching template is used, a result of subsequent distortion value comparison better conforms to a real distortion status, so that a more proper predicted value is selected, thereby improving coding efficiency.

For functional implementation of each unit of the apparatus 800 and a manner of interaction between the units of the apparatus 800 in this embodiment of this application, further refer to descriptions of related method embodiments. Details are not described herein again.

It should be understood that the division of the units in the apparatus 800 is merely division of logical functions. During actual implementation, all or some of the units may be integrated into a physical entity, or may be physically separated. For example, each of the units may be a separately disposed processing element, or may be integrated into a chip of a codec device. Alternatively, each unit may be stored in a form of program code in a storage element of the codec device, and invoked by a processing element of the codec device to perform functions of each unit. In addition, the units may be integrated or separately implemented. The processing element herein may be an integrated circuit chip having a signal processing capability. In an implementation process, the steps of the foregoing methods or the foregoing units may be completed by using a hardware-integrated logic circuit in a processor element or an instruction in a form of software. The processing element may be a general purpose processor, for example, a central processing unit (CPU); or may be configured as one or more integrated circuits for implementing the foregoing methods, for example, one or more application-specific integrated circuits (ASIC), one or more digital signal processors (DSP), or one or more field programmable gate arrays (FPGA).

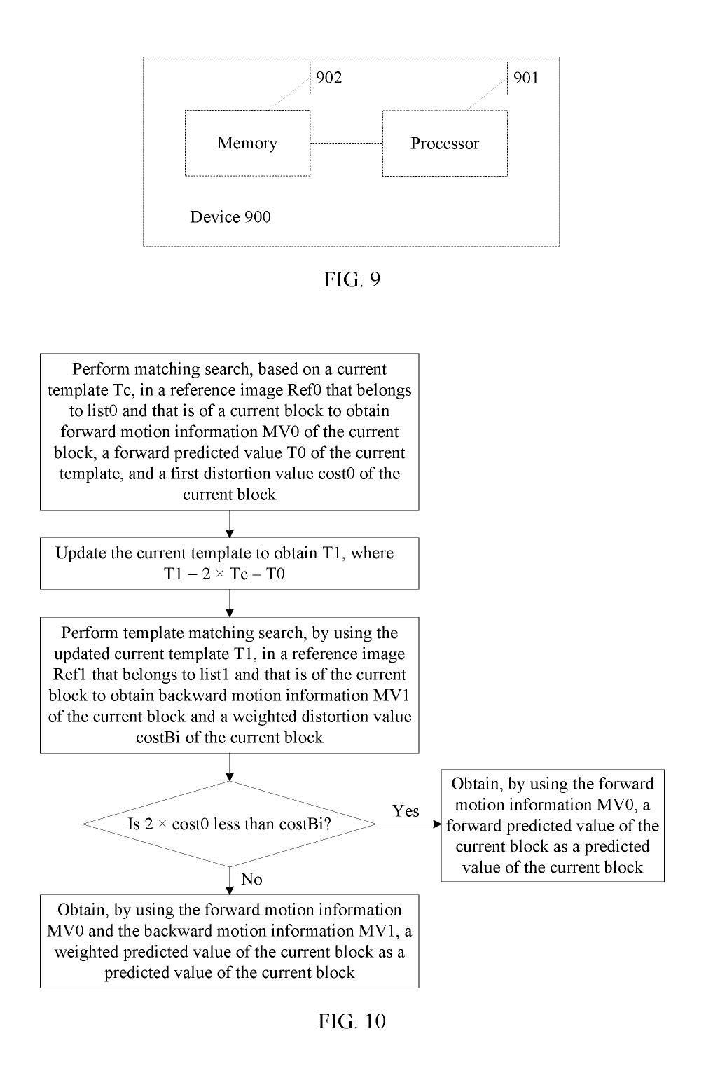

Based on a same application idea, an embodiment of this application further provides a template matching-based prediction device 900. As shown in FIG. 9, the device 900 includes a processor 901 and a memory 902. Program code for executing the solutions of this application is stored in the memory 902, and is used to instruct the processor 901 to perform the prediction methods shown in FIG. 3, FIG. 4A, and FIG. 4B.

In this application, code corresponding to the methods shown in FIG. 3, FIG. 4A, and FIG. 4B may be built into a chip through design and programming of the processor, so that the chip can perform the methods shown in FIG. 3, FIG. 4A, and FIG. 4B when the chip is running.

It may be understood that the processor of the device 900 in this embodiment of this application may be a CPU, a DSP, an ASIC, or one or more integrated circuits configured to control program execution of the solutions of this application. One or more memories included in the device 900 may be a read-only memory (ROM), another type of static storage device that can store static information and an instruction, a random access memory (RAM), or another type of dynamic storage device that can store information and an instruction; or may be a disk storage. These memories are connected to the processor through a bus, or may be connected to the processor through a dedicated connection line.

Persons of ordinary skill in the art may understand that all or some of the steps in the methods of the foregoing embodiments may be implemented by a program instructing a processor. The program may be stored in a computer readable storage medium. The storage medium may be a non-transitory medium, for example, a random access memory, a read-only memory, a flash memory, a hard disk, a solid state drive, a magnetic tape, a floppy disk, a compact disc, or any combination thereof.

In a specific embodiment of the present application, an implementation solution (which may be downloaded from http://phenix.int-evry.fr/jvet/, where all content of this reference document is incorporated, in a citing manner, into this specification) of frame rate up conversion (FRUC) in JVET-D1001 “Algorithm Description of Joint Exploration Test Model 4” has been improved, as shown in FIG. 10. For details about specific feasible implementations, refer to the foregoing descriptions. Details are not described again.

In some embodiments of the present application, backward template matching search needs to rely on a result of forward template matching. Specifically, a matching template obtained during forward template matching search is still needed to update a current template used in backward template matching search. Therefore, the forward template matching search and the backward template matching search cannot be concurrently performed. This affects execution efficiency of the solutions in some special application scenarios.

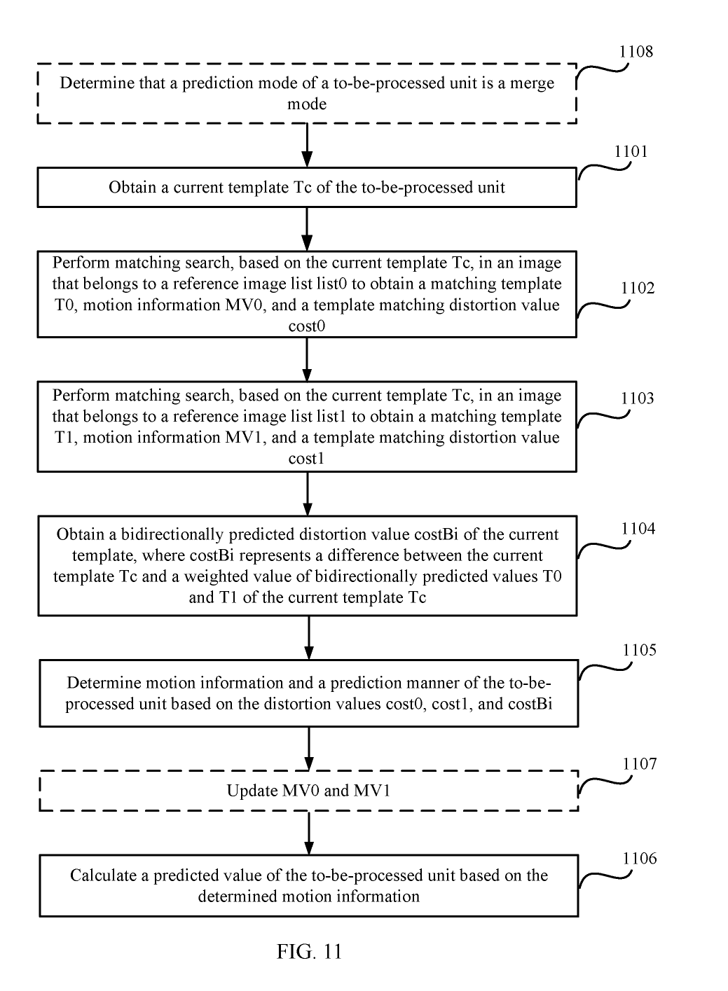

To improve concurrency of solution execution, in a specific embodiment of the present application, as shown in FIG. 11, a template matching-based prediction method includes the following steps.

S1101. Obtain a current template Tc of a to-be-processed unit.

S1102. Perform matching search, based on the current template Tc, in an image that belongs to a reference image list list0 to obtain a matching template T0, motion information MV0, and a template matching distortion value cost0, where cost0 is used to represent a pixel value difference between Tc and T0.

S1103. Perform matching search, based on the current template Tc, in an image that belongs to a reference image list list1 to obtain a matching template T1, motion information MV1, and a template matching distortion value cost1, where cost1 is used to represent a pixel value difference between Tc and T1.

It should be understood that S1102 and S1103 may be concurrently performed, and there is no execution sequence requirement.

It should be understood that, MV0 may be obtained according to a particular frame of reference image in list0 or in some feasible implementations, may be obtained from a multi-frame image of list0. For example, in a multi-reference-frame technology, motion information whose rate distortion cost is the smallest is obtained as MV0, or MV0 is obtained by weighting a plurality of pieces of motion information. MV1 is obtained similarly, and details are not described again.

S1104. Obtain a bidirectional-prediction distortion value costBi of the current template, where costBi represents a difference between the current template Tc and a weighted value of bidirectionally predicted values T0 and T1 of the current template Tc.

In a specific embodiment, costBi may be expressed as a sum of absolute differences between Tc and (0.5*T0+0.5*T1).

S1105. Determine motion information and a prediction manner of the to-be-processed unit based on the distortion values cost0, cost1, and costBi.

Specifically, when costo is the smallest among cost0, cost1, and costBi, the prediction manner is determined as list0-based unidirectional prediction, and the motion information is MV0; or when cost1 is the smallest among cost0, cost1, and costBi, the prediction manner is determined as list1-based unidirectional prediction, and the motion information is MV1; or when costBi is the smallest among cost0, cost1, and costBi, the prediction manner is determined as list0-based and list1-based bidirectional prediction, and the motion information is MV0 and MV1.

S1106. Calculate a predicted value of the to-be-processed unit based on the determined motion information.

It should be understood that, a specific feasible implementation of each step in the foregoing embodiment is similar to that of a corresponding step in each of the previous embodiments, and details are not described again.

In a specific implementation, before step S1106, the method further includes:

S1107. Update MV0 and MV1.

Specifically, for example, before MV0 and MV1 are used in motion compensation to obtain the predicted value, MV0 and MV1 are further updated according to the subblock-level motion vector updating (motion refine) method in JVET-D1001 “Algorithm Description of Joint Exploration Test Model 4”.

In a specific implementation, before step S1101, the method further includes:

S1108. Determine that a prediction mode of the to-be-processed unit is a merge mode.

In other words, the method of steps S1101 to S1106 is performed only in the merge mode.

It should be understood that, in the merge mode, because motion information does not need to be transmitted and a coding cost caused due to motion information coding does not need to be considered, the merge mode better conforms to a manner in which preferential selection is directly performed based on a prediction error cost in this embodiment of the present application, so that selected optimal motion information has higher coding efficiency.

It should be noted that, the foregoing cost value is a distortion value of the current template, and may be a sum of absolute differences SAD, or may be a sum of squares of errors SSE, or another quantity that represents distortion.

In this embodiment of the present application, motion information is adaptively selected, and a mode of selecting the motion information does not need to be coded, to save a coding code rate. In addition, different unidirectional template matching and prediction may be concurrently performed, thereby improving solution execution efficiency.

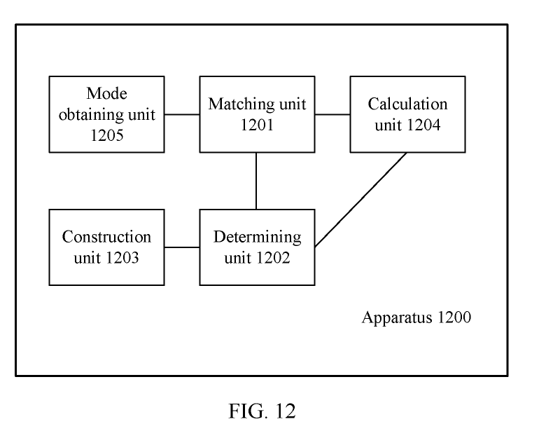

Corresponding to the foregoing embodiment, as shown in FIG. 12, a template matching-based prediction apparatus 1200 includes:

a matching unit 1201, configured to perform matching search separately in at least two reference images of a to-be-processed unit based on a current template to obtain, at each time of the matching search, one set of motion information, one unidirectional matching template, and one unidirectional template distortion value that are corresponding to the reference image, where the current template includes a plurality of reconstructed pixels with a preset quantity at preset positions in a neighboring domain of the to-be-processed unit, and the unidirectional template distortion value represents a difference between the current template and the unidirectional matching template;

a determining unit 1202, configured to determine, as target motion information of the to-be-processed unit, motion information corresponding to a smallest one of the obtained unidirectional template distortion values; and

a construction unit 1203, configured to construct a predicted value of the to-be-processed unit based on the target motion information.

In a feasible implementation, the prediction apparatus further includes a calculation unit 1204, configured to: after the matching search is performed separately in the at least two reference images of the to-be-processed unit based on the current template to obtain, at each time of the matching search, one set of motion information, one unidirectional matching template, and one unidirectional template distortion value that are corresponding to the reference image, obtain a weighted template distortion value based on pixel values of two of the unidirectional matching templates, where the weighted template distortion value represents a weighted difference between the current template and the two unidirectional matching templates, and the weighted template distortion value is corresponding to two sets of motion information corresponding to the two unidirectional matching templates; and correspondingly, the determining unit 1202 is configured to: determine, as the target motion information, motion information corresponding to a smallest one of the obtained unidirectional template distortion values and the weighted template distortion value.

In a feasible implementation, the construction unit 1203 is configured to:

when the target motion information includes only a first set of motion information, obtain, based on the first set of motion information, the predicted value of the to-be-processed unit from a first reference image corresponding to the first set of motion information; or

when the target motion information includes only a second set of motion information and a third set of motion information, obtain, based on the second set of motion information, a second predicted value from a second reference image corresponding to the second set of motion information; obtain, based on the third set of motion information, a third predicted value from a third reference image corresponding to the third set of motion information; and determine a calculated weighted value of the second predicted value and the third predicted value as the predicted value of the to-be-processed unit.

In a feasible implementation, the matching unit 1201 is configured to: traverse, in reconstructed pixels within a preset range of the reference image, a plurality of candidate reconstructed-pixel combinations that have a same size and a same shape as the current template, and calculate a plurality of pixel differences between the plurality of candidate reconstructed-pixel combinations and the current template;

determine the unidirectional matching template and the unidirectional template distortion value based on a smallest one of the pixel differences, where the unidirectional matching template includes a candidate reconstructed-pixel combination corresponding to the unidirectional template distortion value; and

determine the motion information based on the reference image and a position vector difference between the unidirectional matching template and the current template.

In a feasible implementation, the matching unit 1201 is configured to: perform the matching search in at least one reference image of a forward reference image list of the to-be-processed unit based on the current template to obtain one set of forward motion information, one forward matching template, and one forward template distortion value; and perform the matching search in at least one reference image of a backward reference image list of the to-be-processed unit based on the current template to obtain one set of backward motion information, one backward matching template, and one backward template distortion value.

In a feasible implementation, the obtaining a weighted template distortion value based on pixel values of two of the unidirectional matching templates is expressed by using the following formula:

Tw=|ω0×T1+(1−ω0)×T2−Tc|

where Tw represents the weighted template distortion value, T1 and T2 represent the pixel values of the two unidirectional matching templates, Tc represents a pixel value of the current template, ω0 represents a weighting coefficient, ω0≥0, and ω0≤1.

In a feasible implementation, the prediction apparatus further includes a mode obtaining unit 1205, configured to: before the matching search is performed in the at least two reference images of the to-be-processed unit based on the current template, determine that a prediction mode of the to-be-processed unit is a merge mode.

In this embodiment of the present application, motion information is adaptively selected, and a mode of selecting the motion information does not need to be coded, to save a coding code rate. In addition, different unidirectional template matching and prediction may be concurrently performed, thereby improving solution execution efficiency.

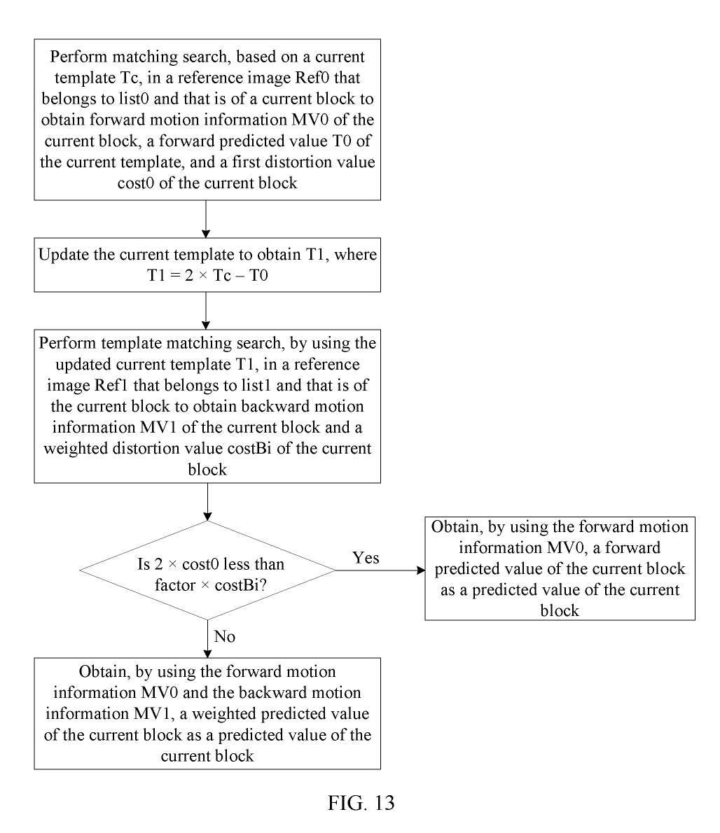

In an example embodiment of the present application, as shown in FIG. 13, a template matching-based prediction method includes the following steps.

1. Perform matching search, based on a current template Tc, in a reference image Ref0 that belongs to list0 and that is of a current block to obtain forward motion information MV0 of the current block, a forward predicted value T0 of the current template (namely, a pixel value of a matching template), and a first distortion value cost0 between the current template and the forward predicted value of the current template.

2. Update the current template by using the following formula:

T1=2×Tc−T0

where T1 represents a pixel value of the updated current template.

3. Perform template matching search, by using the updated current template T1, in a reference image Ref1 that belongs to list1 and that is of the current block to obtain backward motion information MV1 of the current block, and a weighted distortion value costBi between the updated current template and a backward predicted value of the current template.

4. Compare 2×cost0 and adjusted costBi.

In a feasible implementation, the adjusted costBi is equal to factor×costBi, where factor is an adjustment coefficient whose value is a real number greater than 0 and less than or equal to 1. For example, factor may be 1/1.1, or 1/1.2, or 1/1.3. Specifically, under a general test condition organized by the foregoing JCTVC standard, different coding gains obtained by using different factors are shown in the following table:

| | Adjustment coefficient | | | | | | | | |
|---|---|---|---|---|---|---|---|---|---|
| | 1 | | | 1/1.1 | | | 1/1.2 | | |
| | Brightness/Chroma | | | | | | | | |
| | Brightness | Chroma 1 | Chroma 2 | Brightness | Chroma 1 | Chroma 2 | Brightness | Chroma 1 | Chroma 2 |
| Average gain | 0.35% | 0.22% | 0.25% | 0.49% | 0.37% | 0.44% | 0.53% | 0.45% | 0.49% |

5. Select, based on a comparison result of 2×cost0 and the adjusted costBi, a prediction manner corresponding to a smaller one of 2×cost0 and the adjusted costBi to obtain a predicted value of the current block.

Specifically, if 2×cost0 is less than factor×costBi, a forward predicted value of the current block is obtained from a forward reference image of the current block by using the forward motion information MV0, and is used as the predicted value of the current block.

If 2×cost0 is not less than factor×costBi, a forward predicted value of the current block is obtained from a forward reference image of the current block by using the forward motion information MV0 and the backward motion information MV1, a backward predicted value of the current block is obtained from a backward reference image of the current block, and weighting calculation is performed on the forward predicted value of the current block and the backward predicted value of the current block to obtain the predicted value of the current block.

It should be understood that, a specific feasible implementation of each step in the foregoing embodiment is similar to that of a corresponding step in each of the previous embodiments, and details are not described again.

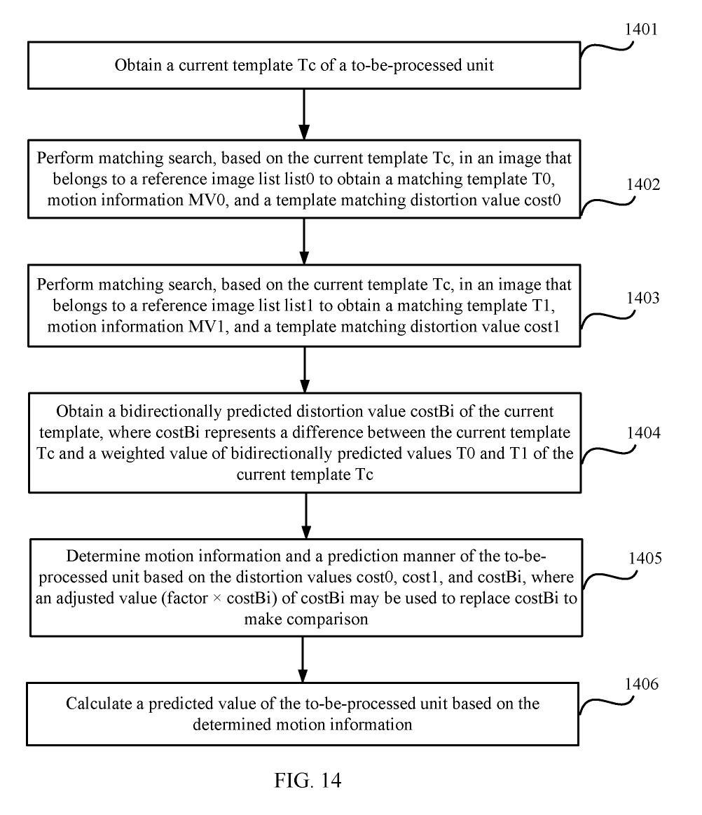

In an example embodiment of the present application, as shown in FIG. 14, a template matching-based prediction method includes the following steps.

S1401. Obtain a current template Tc of a to-be-processed unit.

S1402. Perform matching search, based on the current template Tc, in an image that belongs to a reference image list list0 to obtain a matching template T0, motion information MV0, and a template matching distortion value cost0, where cost0 is used to represent a pixel value difference between Tc and T0.

S1403. Perform matching search, based on the current template Tc, in an image that belongs to a reference image list list1 to obtain a matching template T1, motion information MV1, and a template matching distortion value cost1, where cost1 is used to represent a pixel value difference between Tc and T1.

It should be understood that S1402 and S1403 may be concurrently performed, and there is no execution sequence requirement.

It should be understood that, MV0 may be obtained according to a particular frame of reference image in list0 or in some feasible implementations, may be obtained from a multi-frame image of list0. For example, in a multi-reference-frame technology, motion information whose rate distortion cost is the smallest is obtained as MV0, or MV0 is obtained by weighting a plurality of pieces of motion information. MV1 is obtained similarly, and details are not described again.

S1404. Obtain a bidirectional-prediction distortion value costBi of the current template, where costBi represents a difference between the current template Tc and a weighted value of bidirectionally predicted values T0 and T1 of the current template Tc.

In a specific embodiment, costBi may be expressed as a sum of absolute differences between Tc and (0.5*T0+0.5*T1).

S1405. Determine motion information and a prediction manner of the to-be-processed unit based on the distortion values cost0, cost1, and costBi.

In a feasible implementation, costBi may be adjusted, and adjusted costBi is equal to factor×costBi, where factor is an adjustment coefficient whose value is a real number greater than 0 and less than or equal to 1. For example, factor may be 1/1.1, or 1/1.2, or 1/1.3.

Specifically, when costo is the smallest among cost0, cost1, and factor×costBi, the prediction manner is determined as list0 based unidirectional prediction, and the motion information is MV0; or when cost1 is the smallest among cost0, cost1, and factor×costBi, the prediction manner is determined as list1-based unidirectional prediction, and the motion information is MV1; or when factor×costBi is the smallest among cost0, cost1, and factor×costBi, the prediction manner is determined as list0 based and list1-based bidirectional prediction, and the motion information is MV0 and MV1.

S1406. Calculate a predicted value of the to-be-processed unit based on the determined motion information.

It should be understood that, a specific feasible implementation of each step in the foregoing embodiment is similar to that of a corresponding step in each of the previous embodiments, and details are not described again.

This application is described with reference to respective flowcharts and block diagrams of the methods and the devices in the embodiments of this application. It should be understood that computer program instructions may be used to implement each process and each block in the flowcharts and the block diagrams and a combination of a process and a block in the flowcharts and the block diagrams. These computer program instructions may be provided for a general-purpose computer, a special-purpose computer, an embedded processor, or a processor of any other programmable data processing device to generate a machine, so that the instructions executed by a computer or a processor of any other programmable data processing device generate an apparatus for implementing a specific function in one or more processes in the flowcharts and in one or more blocks in the block diagrams.

What is claimed is:

1. A method for prediction based on template matching, the method comprising:
performing matching search separately in at least two reference images of a to-be-processed unit based on a current template to obtain, at each time of the matching search for a given reference image, one set of motion information, one unidirectional matching template, and one unidirectional template distortion value that are corresponding to the given reference image, wherein the current template comprises a plurality of reconstructed pixels with a preset quantity at preset positions in a neighboring domain of the to-be-processed unit, and the unidirectional template distortion value represents a difference between the current template and the unidirectional matching template;
determining, as target motion information of the to-be-processed unit, motion information corresponding to a smallest one of the obtained unidirectional template distortion values; and
constructing a predicted value of the to-be-processed unit based on the target motion information.

2. The method according to claim 1, wherein after the performing matching search separately in the at least two reference images of the to-be-processed unit, the method further comprises:
obtaining a weighted template distortion value based on pixel values of two of the unidirectional matching templates, wherein the weighted template distortion value represents a weighted difference between the current template and the two unidirectional matching templates, and the weighted template distortion value is corresponding to two sets of motion information corresponding to the two unidirectional matching templates; and
wherein the determining, as the target motion information of the to-be-processed unit, the motion information corresponding to the smallest one of the obtained unidirectional template distortion values comprises:
determining, as the target motion information, motion information corresponding to a smallest one of the obtained unidirectional template distortion values and the weighted template distortion value.

3. The method according to claim 1, wherein the constructing the predicted value of the to-be-processed unit based on the target motion information comprises:
in response to determining that the target motion information comprises a first set of motion information,
obtaining, based on the first set of motion information, the predicted value of the to-be-processed unit from a first reference image corresponding to the first set of motion information; or
in response to determining that the target motion information comprises a second set of motion information and a third set of motion information,
obtaining, based on the second set of motion information, a second predicted value from a second reference image corresponding to the second set of motion information;
obtaining, based on the third set of motion information, a third predicted value from a third reference image corresponding to the third set of motion information; and
determining a weighted value of the second predicted value and the third predicted value as the predicted value of the to-be-processed unit.

4. The method according to claim 1, wherein the performing matching search comprises:
traversing, in reconstructed pixels within a preset range of the reference image, a plurality of candidate reconstructed-pixel combinations that have a same size and a same shape as the current template, and calculating a plurality of pixel differences between the plurality of candidate reconstructed-pixel combinations and the current template;
determining the unidirectional matching template and the unidirectional template distortion value based on a smallest one of the pixel differences, wherein the unidirectional matching template comprises a candidate reconstructed-pixel combination corresponding to the unidirectional template distortion value; and
determining the motion information based on the reference image and a position vector difference between the unidirectional matching template and the current template.

5. The method according to claim 1, wherein the performing matching search separately in the at least two reference images of the to-be-processed unit based on the current template comprises:
performing the matching search in at least one reference image of a forward reference image list of the to-be-processed unit based on the current template to obtain one set of forward motion information, one forward matching template, and one forward template distortion value; and
performing the matching search in at least one reference image of a backward reference image list of the to-be-processed unit based on the current template to obtain one set of backward motion information, one backward matching template, and one backward template distortion value.

6. The method according to claim 2, wherein the obtaining the weighted template distortion value based on the pixel values of two of the unidirectional matching templates is expressed by using the following formula:
Tw=|ω0×T1+(1−ω0)×T2−Tc|,
wherein Tw represents the weighted template distortion value, T1 and T2 represent the pixel values of the two unidirectional matching templates, Tc represents a pixel value of the current template, ω0 represents a weighting coefficient, ω0≥0, and ω0≤1.

7. The method according to claim 1, before the performing matching search separately in the at least two reference images of the to-be-processed unit based on the current template, the method further comprises:
determining that a prediction mode of the to-be-processed unit is a merge mode.

8. The method according to claim 2, wherein before the determining, as the target motion information, the motion information corresponding to the smallest one of the obtained unidirectional template distortion values and the weighted template distortion value, the method further comprises:
adjusting the weighted template distortion value to obtain an adjusted weighted template distortion value; and
wherein the determining, as the target motion information, the motion information corresponding to the smallest one of the obtained unidirectional template distortion values and the weighted template distortion value comprises:
determining, as the target motion information, motion information corresponding to a smallest one of the obtained unidirectional template distortion values and the adjusted weighted template distortion value.

9. The method according to claim 8, wherein the adjusting the weighted template distortion value to obtain the adjusted weighted template distortion value comprises:
multiplying the weighted template distortion value by an adjustment coefficient to obtain the adjusted weighted template distortion value, wherein the adjustment coefficient is greater than 0 and less than or equal to 1.

10. An apparatus for prediction based on template matching, the apparatus comprising:
a non-transitory memory having processor-executable instructions stored thereon; and
a processor, coupled to the non-transitory memory, configured to execute the processor-executable instructions to facilitate:
performing matching search separately in at least two reference images of a to-be-processed unit based on a current template to obtain, at each time of the matching search for a given reference image, one set of motion information, one unidirectional matching template, and one unidirectional template distortion value that are corresponding to the given reference image, wherein the current template comprises a plurality of reconstructed pixels with a preset quantity at preset positions in a neighboring domain of the to-be-processed unit, and the unidirectional template distortion value represents a difference between the current template and the unidirectional matching template;
determining, as target motion information of the to-be-processed unit, motion information corresponding to a smallest one of the obtained unidirectional template distortion values; and
constructing a predicted value of the to-be-processed unit based on the target motion information.

11. The apparatus according to claim 10, wherein after the matching search is performed separately in the at least two reference images of the to-be-processed unit, the processor is configured to execute the processor-executable instructions to further facilitate:
obtaining a weighted template distortion value based on pixel values of two of the unidirectional matching templates, wherein the weighted template distortion value represents a weighted difference between the current template and the two unidirectional matching templates, and the weighted template distortion value is corresponding to two sets of motion information corresponding to the two unidirectional matching templates; and
determining, as the target motion information, motion information corresponding to a smallest one of the obtained unidirectional template distortion values and the weighted template distortion value.

12. The apparatus according to claim 10, wherein the processor is configured to execute the processor-executable instructions to further facilitate:
in response to determining that the target motion information comprises a first set of motion information,
obtaining, based on the first set of motion information, the predicted value of the to-be-processed unit from a first reference image corresponding to the first set of motion information; or
in response to determining that the target motion information comprises a second set of motion information and a third set of motion information,
obtaining, based on the second set of motion information, a second predicted value from a second reference image corresponding to the second set of motion information;
obtaining, based on the third set of motion information, a third predicted value from a third reference image corresponding to the third set of motion information; and
determining a calculated weighted value of the second predicted value and the third predicted value as the predicted value of the to-be-processed unit.

13. The apparatus according to claim 10, wherein the processor is configured to execute the processor-executable instructions to further facilitate:
traversing, in reconstructed pixels within a preset range of the reference image, a plurality of candidate reconstructed-pixel combinations that have a same size and a same shape as the current template, and calculate a plurality of pixel differences between the plurality of candidate reconstructed-pixel combinations and the current template;
determining the unidirectional matching template and the unidirectional template distortion value based on a smallest one of the pixel differences, wherein the unidirectional matching template comprises a candidate reconstructed-pixel combination corresponding to the unidirectional template distortion value; and
determining the motion information based on the reference image and a position vector difference between the unidirectional matching template and the current template.

14. The apparatus according to claim 10, wherein the processor is configured to execute the processor-executable instructions to further facilitate:
performing the matching search in at least one reference image of a forward reference image list of the to-be-processed unit based on the current template to obtain one set of forward motion information, one forward matching template, and one forward template distortion value; and
performing the matching search in at least one reference image of a backward reference image list of the to-be-processed unit based on the current template to obtain one set of backward motion information, one backward matching template, and one backward template distortion value.

15. The apparatus according to claim 11, wherein the obtaining the weighted template distortion value based on the pixel values of two of the unidirectional matching templates is expressed by using the following formula:
Tw=|ω0×T1+(1−ω0)×T2−Tc|,
wherein Tw represents the weighted template distortion value, T1 and T2 represent the pixel values of the two unidirectional matching templates, Tc represents a pixel value of the current template, ω0 represents a weighting coefficient, ω0≥0, and ω0 ≤1.

16. The apparatus according to claim 10, wherein before the performing matching search separately in the at least two reference images of the to-be-processed unit, the processor is configured to execute the processor-executable instructions to further facilitate:
determining that a prediction mode of the to-be-processed unit is a merge mode.

17. The apparatus according to claim 11, wherein the processor is configured to execute the processor-executable instructions to further facilitate:
adjusting the weighted template distortion value to obtain an adjusted weighted template distortion value; and
determining, as the target motion information, motion information corresponding to a smallest one of the obtained unidirectional template distortion values and the adjusted weighted template distortion value.

18. The apparatus according to claim 17, wherein the processor is configured to execute the processor-executable instructions to further facilitate:
multiplying the weighted template distortion value by an adjustment coefficient to obtain the adjusted weighted template distortion value, wherein the adjustment coefficient is greater than 0 and less than or equal to 1.

19. A method for prediction based on template matching, the method comprising:
performing matching search in a first reference image of a to-be-processed unit based on a current template to obtain first motion information, a first matching template, and a first template distortion value that are of the to-be-processed unit, wherein the current template comprises a plurality of reconstructed pixels with a preset quantity at preset positions in a neighboring domain of the to-be-processed unit, and the first template distortion value represents a difference between the first matching template and the current template;
updating a pixel value of the current template based on a pixel value of the first matching template;
performing matching search in a second reference image of the to-be-processed unit based on the updated current template to obtain second motion information, a second matching template, and a second template distortion value that are of the to-be-processed unit, wherein the second template distortion value represents a difference between the second matching template and the updated current template; and
determining a weighted predicted value of the to-be-processed unit based on the first motion information and the second motion information when the second template distortion value is less than the first template distortion value.

20. The method according to claim 19, wherein the updating the pixel value of the current template based on the pixel value of the first matching template comprises updating the pixel value of the current template in the following manner:
T1=(T0−ω0×P1)/(1−ω0),
wherein T1 represents a pixel value of the updated current template, T0 represents the pixel value of the current template, P1 represents the pixel value of the first matching template, ω0 represents a weighting coefficient corresponding to the first matching template, and ω0 is a positive number less than 1.
